(19) United States
(12) Patent Application Publication
(10) Pub. No.: US 2025/0358387 A1
(43) Pub. Date: Nov. 20, 2025

(54) METHOD OF REPETITIVE PATTERN-AWARE INTERPOLATION OF VIDEO FRAMES, AND DEVICE AND MEDIUM IMPLEMENTING SAID METHOD

(71) Applicant: SAMSUNG ELECTRONICS CO., LTD., Suwon-si (KR)

(72) Inventors: Petr POHL, Lobnya (RU); Iurii Gennadievich FETISOV, Shchekino (RU); Igor Mironovich KOVLIGA, Moscow (RU); Andrei Vladimirovich ZUBIUK, Moscow (RU); Mikhail Sergeevich LOMAEV, Sheksna (RU); Dmitrii Sergeevich KONOVALCHUK, Togliatti (RU); Sujung BAE, Suwon-si (KR)

(73) Assignee: SAMSUNG ELECTRONICS CO., LTD., Suwon-si (KR)

(21) Appl. No.: 19/212,155

(22) Filed: May 19, 2025

Related U.S. Application Data
(63) Continuation of application No. PCT/KR2025/004916, filed on Apr. 11, 2025.

(30) Foreign Application Priority Data
May 20, 2024 (RU) 2024113538

(51) Int. Cl. H04N 7/01; G06V 10/60; G06V 10/74; G06V 10/82; H04N 5/14

(52) U.S. Cl. CPC H04N 7/014; G06V 10/60; G06V 10/761; G06V 10/82; H04N 5/145; H04N 7/0137

(57) ABSTRACT

A method for interpolating video frames, includes: obtaining at least two key frames of a video, for which a motion estimation is to be performed, detecting repetitive pattern regions on the at least one key frame of the at least two key frames, estimating motion between the at least one key frame of the at least two key frames and the interpolated frame being interpolated by feeding the at least two key frames and the repetitive pattern regions to a trained motion estimation neural network.

### CROSS-REFERENCE TO RELATED APPLICATIONS

This application is a by-pass continuation application of International Application No. PCT/KR2025/004916, filed on Apr. 11, 2025, which is based on and claims priority to Russian Patent Application No. 2024113538, filed on May 20, 2024, in the Korean Intellectual Property Office, the disclosures of which are incorporated by reference herein their entireties.

### BACKGROUND

### 1. Field

The disclosure relates to the field of image processing and, in particular, to a method for repetitive pattern-aware interpolation of video frame(s) and to a device and computer-readable medium implementing the method. The frame(s) interpolation proposed herein may be used in a variety of applications, such as Frame Rate Conversion (FRC), view synthesis for multi-view sequences, and any other applications in which frame interpolation may be required.

### 2. Description of Related Art

To convert the frame rate, Motion Compensated Frame Interpolation (MCFI) is applicable in the related art. When implementing these methods, classical approaches can be used, in which traditional, classical (handcrafted) algorithms are used, and artificial neural networks as such are not applied. In particular, operations known in the art such as Motion Estimation (ME), motion estimation correction, Motion Compensation (MC), as well as occlusion detection, etc. can be implemented based on classical algorithms.

One problem with the related art classical approaches is that motion estimation may not be performed correctly when the frames, for which such an estimation is obtained, comprise patterns that appear multiple times in the image with little or essentially no change (i.e. repetitive patterns). As an example, if there is a plurality of identical fence bars in the frames, the classic ME algorithm may erroneously find the motion vector from bar 1 in frame 1 to bar 2 in frame 2, which is the error and leads to an appearance in the frame that will be obtained by interpolating the frame by the basis of such an incorrect motion estimation, of serious artifacts, for example, ghosting, blurring, the appearance of falling-to-pieces objects that are not in their original place, but are somehow displaced, etc. (see FIG. 1 (related art)). The artifacts appeared due to this problem are among the most noticeable artifacts generated in video frame interpolation that does not take into account repetitive patterns.

The other more recent approach used in the related art for frame rate conversion is the application of artificial neural networks (NNs), including deep neural networks (DNNs). This approach provides a higher quality compared to classical approaches. This approach, in turn, can be divided into flow-based methods and methods based on complex (end-to-end) neural networks. In flow-based methods, one neural network may be responsible for motion estimation, the other neural network may be responsible for occlusion detection, etc., at the same time, the additional application of classical algorithms or other neural networks for other purposes (for example, for motion compensation purposes) is not excluded. In methods based on complex (end-to-end) neural networks, the latter carry out all processing internally and operate on the principle of a black box that takes key frames as input and outputs interpolated frames at once. Related art NN-based methods, as well as classical approaches, suffer from artifacts appeared due to incorrect matching of repetitive patterns presented in frames when estimating motion between the frames.

Complex NN architectures involve a large number of layers, at least some of which are responsible for implementing computationally complex operations. At the same time, training NNs with complex architecture requires large amounts of high-quality training data. As a result, complex NNs operate on a huge number of parameters, which significantly complicates their training and subsequent use. As the example, known from the source [1] Z. Shi et al., “Video Frame Interpolation Transformer” (CVPR 2022) is the transformer used for interpolation of video frames, which operates with almost 30 million parameters; and the neural network disclosed in the other source [2] W. Bao et al., “Depth-Aware Video Frame Interpolation” (CPVR 2019), operates with almost 25 million parameters (see the comparison of the neural networks by the number of parameters in FIG. 14).

In summary, there are already discovered algorithms in the related art, which are relatively lightweight in terms of computational complexity and can be used in classical approaches for frame rate conversion. Therefore, classical approaches, in contrast to approaches based on neural networks, can be quite easily applied on electronic devices that do not have significant computing and/or memory resources. But there is the problem of insufficient quality, especially in the context of processing repetitive patterns (namely, accurately estimating motion in repetitive pattern regions) when interpolating video frames. Classical approaches produce frames with a large amount of visually noticeable artifacts (according to both objective and subjective metrics) in comparison with the approach based on neural networks.

On the other hand, the approaches based on neural networks are state-of-the-art and provide higher quality compared to classical approaches, but are expensive in terms of resources consumed. In particular, training complex neural networks is a computationally complex, time-consuming and expensive procedure (in terms of resources consumed, both monetary and other, for example, energy resources consumed by a data processing center in training a complex neural network), which requires the collection and, in some cases, additional processing of large amounts of training data. The subsequent use of such complex neural networks is also time-consuming (i.e., not real-time implementable) on electronic devices (e.g., mobile phones) with limited processor and/or memory resources, i.e. on such devices that typically do not have the most advanced computing components and/or the most advanced memory components. At the same time, the approaches based on neural networks still do not provide ideal quality, since certain videos processed using neural networks still exhibit shortcomings and artifacts associated with incorrect motion estimation in frame regions containing repetitive patterns (structures).

### SUMMARY

The disclosure solves the above problems by being a tradeoff that combines the advantages of both approaches (classical and neural network-based), and the negative impact of the disadvantages of these approaches is restricted to the greatest extent currently possible.

The disclosure is operable at electronic devices with limited resources, and the claimed solution improves the quality of interpolated frames due to more accurate estimation of motion in regions of repetitive patterns taken into account when performing frame interpolation. Other advantageous effects of the disclosed solution will become apparent to those of ordinary skill in the art upon reading the following detailed description of non-limiting embodiments of the disclosure.

According to an aspect of the disclosure, a method for interpolating video frames, includes: obtaining at least two key frames of a video, for which a motion estimation is to be performed, wherein at least one key frame of the at least two key frames is an interpolated frame, detecting repetitive pattern regions on the at least one key frame of the at least two key frames, estimating motion between the at least one key frame of the at least two key frames and the interpolated frame being interpolated by feeding the at least two key frames and the repetitive pattern regions to a trained motion estimation neural network, wherein, when a training of the motion estimation neural network is performed, a value of a loss function is calculated as the sum of: (i) a loss related with a degree of similarity between a reference interpolation frame and the interpolated frame, and (ii) the loss related with the degree of self-similarity of motion vectors obtained by motion estimation in the training of the motion estimation neural network, wherein the motion vectors belong to a repetitive pattern region detected on the reference interpolation frame, obtaining the interpolated frame by performing motion compensation using the at least one key frame and the estimated motion vectors.

In the first aspect of the disclosure, there is provided the method for interpolating video frames, which comprises the steps of: obtaining at least two key frames of a video, for which a motion estimation is to be performed, with which and at least one key frame an interpolated frame is to be obtained; detecting repetitive pattern regions on the at least one key frame of the at least two key frames; estimating motion between the at least one key frame of the at least two key frames and the frame being interpolated by feeding the at least two key frames and the repetitive pattern regions that are detected on the at least one key frame to a trained motion estimation neural network, wherein, when training the motion estimation neural network, a value of a loss function is calculated as the sum of (i) the loss related with the degree of similarity between a reference interpolation frame and an interpolated frame, and (ii) the loss related with the degree of self-similarity of those motion vectors from the motion vectors obtained by motion estimation in the training, which belong to a repetitive pattern region detected on the reference interpolation frame; obtaining the interpolated frame by performing motion compensation using the at least one key frame and the estimated motion vectors.

According to the development of the first aspect of the disclosure, when training the motion estimation neural network, the following is further performed: applying regularization to those motion vectors of the motion vectors obtained by motion estimation in the training between the at least one key frame and the frame being interpolated, which belong to the repetitive pattern region detected on the reference interpolation frame, wherein calculation of (ii) the loss related with the degree of self-similarity is performed before application of the regularization or after application of the regularization.

According to the development of the first aspect of the disclosure, the motion being estimated are motion vectors into the at least one key frame or motion vectors from the at least one key frame.

According to the development of the first aspect of the disclosure, when the motion vectors being estimated are motion vectors into the at least one key frame, the motion vectors that belong to the repetitive pattern region are motion vectors that begin in the repetitive pattern region, or when the motion vectors being estimated are motion vectors from the at least one key frame, the motion vectors that belong to the repetitive pattern region are motion vectors that end in the repetitive pattern region.

According to the development of the first aspect of the disclosure, the regularization of motion vectors is performed by applying to the motion vectors in the repetitive pattern region (one of a local moving average, a global average, or a mode).

According to the development of the first aspect of the disclosure, detecting repetitive pattern regions on the frame comprises: obtaining a first map of repetitive pattern features by block-by-block processing of the frame in a first direction and a second map of repetitive pattern features by block-by-block processing of the frame in a second direction, combining the first map of repetitive pattern features and the second map of repetitive pattern features into a combined map of repetitive pattern features, determining repetitive pattern regions from the combined map of repetitive pattern features, wherein the repetitive pattern region are two or more adjacent blocks of the frame, for which repetitive pattern features are set in the combined map of repetitive pattern features.

According to the development of the first aspect of the disclosure, the first direction is orthogonal to the second direction.

According to the development of the first aspect of the disclosure, the first and second directions are, respectively, the horizontal and vertical directions, or the first and second directions are, respectively, the vertical and horizontal directions, or the first and second directions are, respectively, a direction angled to the horizontal or vertical direction and a direction that is orthogonal to the direction angled to the horizontal or vertical direction.

According to the development of the first aspect of the disclosure, detecting repetitive pattern regions on the frame comprises: obtaining a map of horizontally repetitive pattern features by block-by-block processing of the frame in the horizontal direction, a map of vertically repetitive pattern features by block-by-block processing of the frame in the vertical direction, a map of first diagonally repetitive pattern features by block-by-block processing of the frame in the first diagonal direction, and a map of second diagonally repetitive pattern features by block-by-block processing of the frame in the second diagonal direction, combining the obtained maps of repetitive pattern features into a combined map of repetitive pattern features, determining repetitive pattern regions from the combined map of repetitive pattern features to obtain repetitive pattern regions, wherein the repetitive pattern region in the map of repetitive pattern regions are two or more adjacent blocks of the frame, for which repetitive pattern features are set in the combined map of repetitive pattern features.

According to the development of the first aspect of the disclosure, the first diagonal direction is the direction from the lower left corner of the frame to the upper right corner of the frame, and the second diagonal direction is the direction from the upper left corner of the frame to the lower right corner of the frame, or the first diagonal direction is the direction from the lower right corner of the frame to the upper left corner of the frame, and the second diagonal direction is the direction from the upper right corner of the frame to the lower left corner of the frame, or the first diagonal direction is the direction from the upper left corner of the frame to the lower right corner of the frame, and the second diagonal direction is the direction from the lower left corner of the frame to the upper right corner of the frame, or the first diagonal direction is the direction from the upper right corner of the frame to the lower left corner of the frame, and the second diagonal direction is the direction from the lower right corner of the frame to the upper left corner of the frame.

According to the development of the first aspect of the disclosure, obtaining a map of repetitive pattern features by block-by-block processing of the frame in a particular direction of the first direction and the second direction comprises performing the following operations for each block of the frame: obtaining a row of aggregated pixels from a frame stripe extending in the particular direction and including a block being processed currently and at least a portion of the surroundings of the block being processed currently on one or both sides of the block being processed currently along the direction, calculating a threshold SAD (Sum of Absolute Differences) value as divided-by-two larger SAD value of SAD value calculated between a central segment of the row of aggregated pixels and a segment pixel-wise shifted to a first side by one pixel, and SAD value calculated between the central segment of the row of aggregated pixels and a segment pixel-wise shifted to a second side by one pixel, calculating a set of SAD values between a reference segment from the row of aggregated pixels and each of the segments resulting from successive pixel-by-pixel shifts relative to the reference segment within the row of aggregated pixels, wherein the size of each of the shifted segments being the same as the size of the reference segment, calculating the standard deviation of intensity of pixels within the central segment, counting the number of SAD values in the set of SAD values, which are less than or equal to the threshold SAD value, setting the repetitive pattern feature in the map of repetitive pattern features for the particular direction for the block being processed currently when (a) the counted number of SAD values is greater than a predetermined threshold value of the number of SAD values and (b) the standard deviation of intensity of pixels within the central segment is greater than a predetermined standard deviation threshold.

According to the development of the first aspect of the disclosure, when, in the operation of setting, at least one of the conditions (a), (b) is not satisfied, the operation of obtaining the map of repetitive pattern features proceeds to processing the next block of the frame without setting in the corresponding map of repetitive pattern features the repetitive pattern feature for the current block.

According to the development of the first aspect of the disclosure, an operation of pixel-wise shift used to obtain the shifted segments in the operation of calculating the set of SAD values is one pixel.

According to the development of the first aspect of the disclosure, selected as the reference segment is the central segment of the row of aggregated pixels or a segment shifted relative to the central segment by one pixel within the row of aggregated pixels in the first or second direction, wherein if the SAD value calculated between the central segment and the segment shifted to the first side within the row of aggregated pixels is greater than the SAD value calculated between the central segment and the segment shifted to the second side within the row of aggregated pixels, the segment shifted to the first side is selected as the reference segment, if the SAD value calculated between the central segment and the segment shifted to the first side within the row of aggregated pixels is less than the SAD value calculated between the central segment and the segment shifted to the second side within the row of aggregated pixels, the segment shifted to the second side is selected as the reference segment, otherwise, the central segment is selected as the reference segment, wherein the longitudinal size of the central and reference segment is equal to the width or height of the block being processed.

According to the development of the first aspect of the disclosure, obtaining the row of aggregated pixels from the frame stripe extending in the particular direction and including the block being processed currently and at least the portion of the surroundings of the block being processed currently, which is located within the frame stripe, comprises: generating at least two subsets of longitudinal rows of pixels from each of at least two longitudinal regions of the frame stripe, wherein the subset of longitudinal rows of pixels includes longitudinal rows of pixels lying in the corresponding longitudinal region of the frame stripe not adjacent to each other, averaging the pixel intensity values of each generated subset of longitudinal pixel rows in a transverse direction of the subset of longitudinal pixel rows to obtain an averaged row of pixels for each of the generated subsets of longitudinal pixel rows, and calculating the standard deviation of intensity of pixels within the central segment of each averaged row of pixels, and determining as the row of aggregated pixels the averaged row of pixels whose center segment has the largest standard deviation of intensity of pixels.

According to the development of the first aspect of the disclosure, in generating subsets of longitudinal rows of pixels each two neighboring longitudinal regions of the frame stripe of the at least two longitudinal regions of the frame stripe have at least one common longitudinal row of pixels.

According to the development of the first aspect of the disclosure, the number of generated subsets of longitudinal rows of pixels and, accordingly, longitudinal regions of the frame stripe is selected depending on the resolution of the frame being processed currently and/or on the size of the frame block being processed currently.

According to the development of the first aspect of the disclosure, the operation of calculating further comprises calculating the standard deviation of intensity of pixels within the central segment of one or more longitudinal rows of pixels of the frame stripe, which do not fall, in the generating, into any subset of longitudinal rows of pixels, and in the operation of determining, determined as the row of aggregated pixels is the longitudinal row of pixels whose central segment has the largest normalized standard deviation of intensity of pixels among the averaged rows of pixels and, additionally, the one or more longitudinal rows of pixels of the frame stripe, which do not fall, in the generating, into any subset of longitudinal rows of pixels.

According to the development of the first aspect of the disclosure, to train the motion estimation deep neural network, training data are prepared as follows: obtaining a plurality of videos to be used as training videos, from each video of the plurality of videos, generating at least one group of frames that are close to each other in time or immediately adjacent in time, each group of frames of the at least one group of frames comprises at least three frames: at least two of which are used as key frames of the video for which estimated is the motion used to obtain the interpolated frame, and at least one frame located in time between the two key frames or at the location of any key frame of the two key frames is used as at least one reference interpolation frame, relative to which the loss of the interpolated frame obtained during training is to be calculated.

According to the development of the first aspect of the disclosure, the motion estimation deep neural network is trained by repeatedly performing the following operations: randomly selecting from the training data a generated group of frames, detecting repetitive pattern regions on at least one key frame and on a reference interpolation frame from the group of frames, independently of the remaining frames, estimating motion between the at least one key frame of the group of frames and the frame being interpolated by feeding the at least two key frames and the repetitive pattern regions that are detected on the at least one key frame to the motion estimation neural network being trained, obtaining an interpolated frame by performing motion compensation using the at least one key frame and the estimated motion vectors, calculating a value of a loss function as the sum of (i) the loss related with the degree of similarity between a reference interpolation frame and the interpolated frame, and (ii) the loss related with the degree of self-similarity of those motion vectors of the motion vectors obtained by motion estimation, which belong to the repetitive pattern region detected on the reference interpolation frame, and performing backpropagation of the loss by calculating gradients and updating parameters of the motion estimation deep neural network being trained.

According to the development of the first aspect of the disclosure, to those motion vectors of the motion vectors obtained by motion estimation, which belong to the repetitive pattern region detected on the reference interpolation frame, regularization is further applied, at the same time, calculation of (ii) the loss related with the degree of self-similarity is performed before application of the regularization or after application of the regularization.

According to the development of the first aspect of the disclosure, the regularization is performed before obtaining the interpolated frame, and using the estimated motion vectors comprising the motion vectors to which regularization has been applied as the estimated motion vectors when performing motion compensation to obtain the interpolated frame.

According to the development of the first aspect of the disclosure, (i) the loss related with the degree of similarity between the reference interpolation frame and the interpolated frame is calculated as the mean absolute error (MAE) between the pixel values of the reference interpolation frame and the pixel values of the interpolated frame.

According to the development of the first aspect of the disclosure, (ii) the loss related with the degree of self-similarity of motion vectors that belong to the repetitive pattern region detected on the reference interpolation frame is calculated separately, for each repetitive pattern region detected on the reference interpolation frame, as a total variation value or a variance, or standard deviation of values of the motion vectors that belong to this region.

According to the development of the first aspect of the disclosure, the operations of training the motion estimation deep neural network are performed a predetermined number of training epochs or until the loss function converges.

According to the development of the first aspect of the disclosure, the motion estimation deep neural network is trained by repeatedly performing the following operations: randomly selecting from the training data a generated group of frames, detecting repetitive pattern regions on all frames of the group of frames, estimating (a) motion vectors into a first key frame closest to the frame being interpolated and motion vectors into a second key frame, different from the first key frame, closest to the frame being interpolated, and (b) weights used to blend the compensated frames obtained in motion compensation using the estimated motion vectors, by feeding the key frames of the group of frames and the repetitive pattern regions detected on the key frames into the motion estimation neural network being trained, obtaining an interpolated frame by performing motion compensation using the closest key frames and (a) the motion vectors and (b) the weights, calculating a value of a loss function as the sum of (i) the loss related with the degree of similarity between a reference interpolation frame and the interpolated frame, and (ii) the loss related with the degree of self-similarity of those motion vectors of the motion vectors obtained by motion estimation, which belong to the repetitive pattern region detected on the reference interpolation frame, and performing backpropagation of the loss by calculating gradients and updating parameters of the motion estimation deep neural network being trained.

According to the development of the first aspect of the disclosure, the method further comprises: performing regularization of those motion vectors of the estimated motion vectors into the first closest key frame from the reference interpolation frame, which begin in the repetitive pattern regions detected on the reference interpolation frame, performing regularization of those motion vectors of the estimated motion vectors into the second closest key frame from the reference interpolation frame, which end in the repetitive pattern regions detected on the reference interpolation frame, wherein calculation of (ii) the loss related with the degree of self-similarity is performed before application of the regularizations or after application of the regularizations.

In the second aspect of the disclosure, there is provided a video frame interpolation device comprising a processor and a storage device, wherein the storage device comprises processor-executable instructions that, when executed, cause the processor to perform the method according to the first aspect of the disclosure or according to any development of the first aspect.

In the third aspect of the disclosure, there is provided a computer-readable medium storing computer-executable instructions that, when executed, cause the computer to perform the method according to the first aspect of the disclosure or according to any development of the first aspect.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is the illustrative comparison, for particular two scenes, of interpolated frames obtained according to the related art without taking into account repetitive pattern regions, reference interpolation frames (ground true scenes) and interpolated frames obtained according to the disclosure taking into account, in motion estimation, repetitive pattern regions;

FIG. 2 is the schematic diagram of the electronic device configured to interpolate video frames in accordance with the disclosure;

FIG. 3 is the flowchart of the method for interpolating video frames according to the embodiment of the disclosure;

FIG. 4 is the flowchart of detecting repetitive pattern regions on the key frame according to the non-limiting implementation of such detecting in the disclosure;

FIG. 5 illustrates operations of detecting repetitive pattern regions on the key frame depicting skyscrapers;

FIG. 6 illustrates the repetitive pattern regions detected on the frame;

FIG. 7 is the flowchart of obtaining a map of repetitive pattern features by block-by-block processing of the frame in the particular direction according to the non-limiting implementation of such obtaining in the disclosure;

FIG. 8 is the flowchart of obtaining a row of aggregated pixels according to the non-limiting implementation of such obtaining in the disclosure;

FIG. 9 illustrates operations of calculating a set of sum of absolute differences (SAD) values between a reference segment (in the non-limiting example shown in this figure, the reference segment coincides with the central segment) and pixel-wise shifted segments; this calculation S105.1.3 is carried out in the process of obtaining the map of repetitive pattern features, described with reference to FIG. 7;

FIG. 10 illustrates operations of obtaining the row of aggregated pixels, carried out in the process of obtaining the map of repetitive pattern features, described with reference to FIG. 7;

FIG. 11 is the flowchart of training the motion estimation neural network according to an embodiment of the disclosure;

FIG. 12A illustrates the schematic representation of the architecture of the motion estimation neural network;

FIG. 12B illustrates the schematic representation of individual blocks applied in the motion estimation neural network architecture;

FIG. 13 illustrates the graph of peak signal-to-noise ratio (PSNR) based comparison of interpolated frames of a single scene obtained by the disclosure and interpolated frames of the same scene obtained according to the related art, i.e. without taking into account the patterns that are repetitive in that scene; and

FIG. 14 illustrates the diagram comparing the motion estimation neural network used in the disclosure with the neural networks used in the related art according to number of parameters.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

Before undertaking the detailed description below, it may be advantageous to set forth definitions of certain words and phrases used throughout the disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items. Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

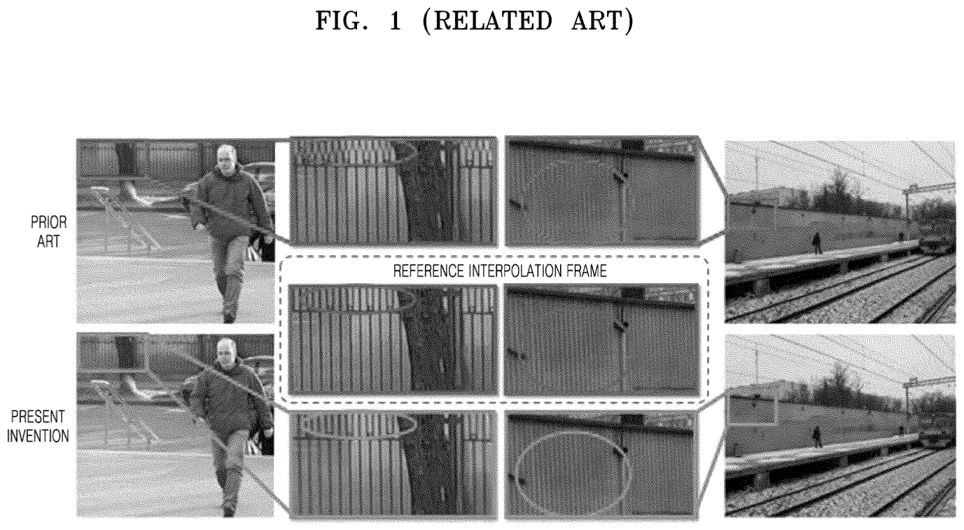

FIG. 1 illustrates frames obtained by the interpolation performed according to the disclosure (that is repetitive pattern-aware when motion estimation is performed), frames obtained by the interpolation performed according to the related art (repetitive pattern-unaware), and reference frames depicting true scenes of two scenes.

In the first scene, the man walks in front of the fence that has many identical bars (i.e., the repetitive pattern); in the second scene, the train arrived at the platform, which also has many structures that are repetitive patterns. As can be judged from those enlarged frame fragments shown in the center of FIG. 1, the frame fragments (bottom row in the center of FIG. 1) obtained by frame interpolation according to the disclosure quite accurately convey the true scene structure (central row in the center of FIG. 1) and do not contain artifacts and distortions as in the corresponding frame fragments (top row in the center of FIG. 1) obtained by frame interpolation according to the related art.

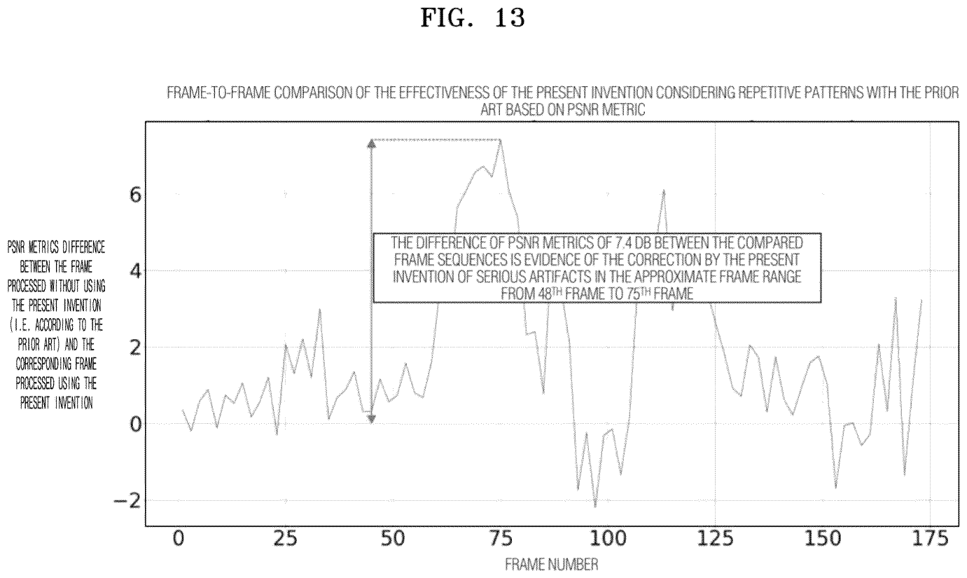

In other words, the difference in the PSNR metrics calculated for the compared frames, i.e. the interpolated frames of two scenes, obtained by the disclosure, and the corresponding interpolated frames of the same two scenes, obtained according to the related art, will be significantly increased (as illustrated by the double-headed arrow in the PSNR metric difference graph of FIG. 13) due to the fact that, in contrast to the related art, the disclosure does not allow the appearance of artifacts shown in the top row in the center of FIG. 1 in the repetitive pattern regions of the frames. This and other advantageous technical effects are achieved due to, at least, detecting repetitive pattern region(s) in a key frame and estimating motion with consideration of the repetitive pattern region(s) by the motion estimation neural network, which has the advantage of being relative lightweight allowing the usage of the disclosure on an electronic device having limited resources in real or near-to-real time. Embodiments and non-limiting implementation examples of the disclosure providing technical advantages over the related art will be described in detail below.

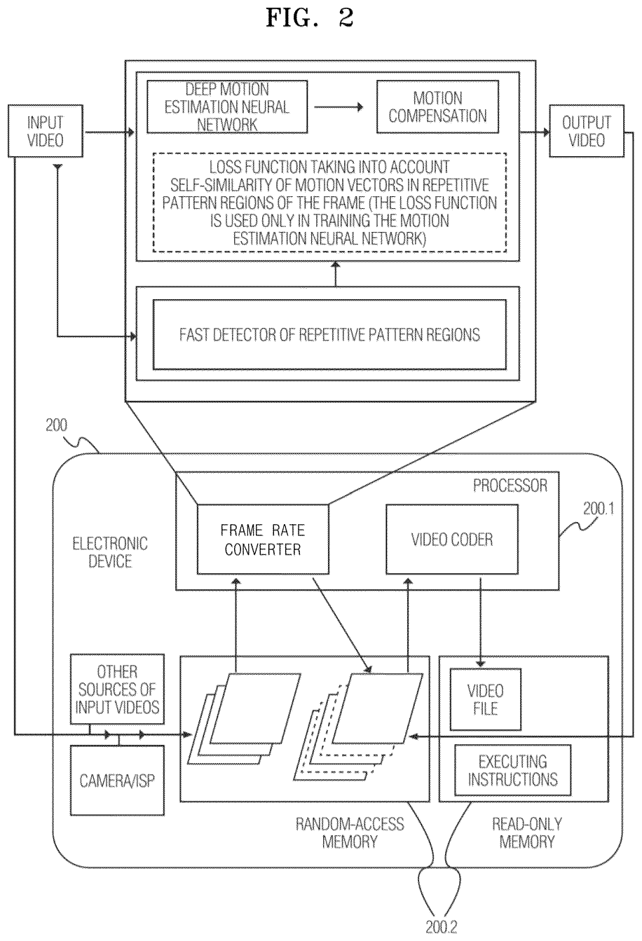

FIG. 2 illustrates the electronic device 200 that is configured to interpolate video frames in accordance with the disclosure. The electronic device 200 comprises a processor 200.1, as well as random-access and read-only memory 200.2. Non-limiting examples of the electronic device 200 include a smartphone, tablet, laptop, AR/VR headset, smartwatch, television set, set-top box, etc. The processor 200.1 may include a Frame Rate Converter (FRC) and a video coder, which may be implemented in software, hardware, or firmware. The FRC can be configured by readable and executable instructions stored in the memory 200.2 to perform the method of interpolating video frames according to the disclosure. The video coder may be implemented as a software, hardware, or firmware video encoder/decoder responsible for encoding/decoding video according to any encoding/decoding standard known in the art, such as, but not limited to, H.264/MPEG-4 AVC, H.265 (HEVC), VVC.

The processor 200.1 may be, but is not limited to, a Central Processing Unit (CPU), a Graphics Processing Unit (GPU), a Neural Processing Unit (NPU), a Digital Signal Processor (DSP), or a combination thereof. The processor 200.1 may be implemented, but not limited to, as a System on Chip (SoC), an Application Specific Integrated Circuit (ASIC), or a Field Programmable Gate Array (FPGA). The random-access memory included in the memory 200.2 may be the random-access memory (RAM) of any type, such as, but not limited to, regular RAM, Dynamic RAM (DRAM), Static RAM (SRAM), Synchronous DRAM (SDRAM), Rambus DRAM (RDRAM), Double Data Rate SDRAM (DDR SDRAM), or a combination thereof. The read-only memory included in the memory 200.2 may be the read-only memory (ROM) of any type, such as, but not limited to, regular ROM, Programmable ROM (PROM), Erasable and Programmable ROM (EPROM), Electrically Erasable and Programmable ROM (EEPROM), NAND flash memory (SSD) or a combination thereof.

As shown in FIG. 2 the FRC includes (i) a fast detector of repetitive pattern regions, which is implemented by classical algorithms, (ii) a motion estimation deep neural network trained using the loss function that takes into account, among other things, the self-similarity of motion vectors in the repetitive pattern region(s), and (iii) a motion compensation unit, which can be implemented by any classical algorithm known from the related art, or by any motion compensation neural network known from the related art. The input video whose frames are to be interpolated may be captured by a camera equipped with an Image Signal Processor (ISP) or obtained from other sources (e.g., from the Internet via a communication link, from the memory, or from any application installed on electronic device 200).

The parameters of the trained (ii) motion estimation deep neural network in the preferred implementation and the corresponding computer-executable instructions may, as shown in FIG. 2, be stored on the electronic device 200 itself (e.g., the memory 200.2). But this should not be interpreted as the limitation, since also possible is the implementation in which the parameters of the trained (ii) motion estimation deep neural network and/or of any other neural network required for the operation (for example, the motion compensation neural network) are stored on a computer server which the electronic device 200 can access via any available communication channel. In this example, the electronic device 200 may transmit to the computer server a request to perform motion estimation with any data required in this case (e.g., with key frames or locators thereof and/or an indication of one or more specific points in time to/from which the motion shall be estimated, which will subsequently be used to obtain the corresponding interpolated frame(s)), and, in response to this request, receive the estimated motion vectors from the computer server.

The FRC (shown in FIG. 2) receives original video frames and outputs original and interpolated video frames, or only interpolated video frames, depending on the implementation. Additional feeding of repetitive pattern regions detected in at least one key frame to the input of the motion estimation deep neural network comprised in the FRC and trained using the loss function that takes into account, among other things, the self-similarity of motion vectors in the repetitive pattern regions, leads to that the motion vector fields estimated by this neural network have regularized motion vectors in the repetitive pattern regions, which ultimately makes it possible to correctly compensate motion in these repetitive pattern regions to obtain an interpolated frame without the artifacts and distortions described above with reference to FIG. 1.

It is important to note that the representation of the electronic device 200 in FIG. 2 is schematic and simplified for purposes of description focused primarily on the features of the disclosure. In an actual implementation, the electronic device 200 may include other components, for example, I/O means (e.g. touch screen, speaker, microphone), one or more communication modules (e.g. Bluetooth, Wi-Fi, LTE, 5G, 6G, etc.), transceiver, antenna, battery, power supply, interconnects, operating system (e.g. Android, iOS, HarmonyOS), etc.

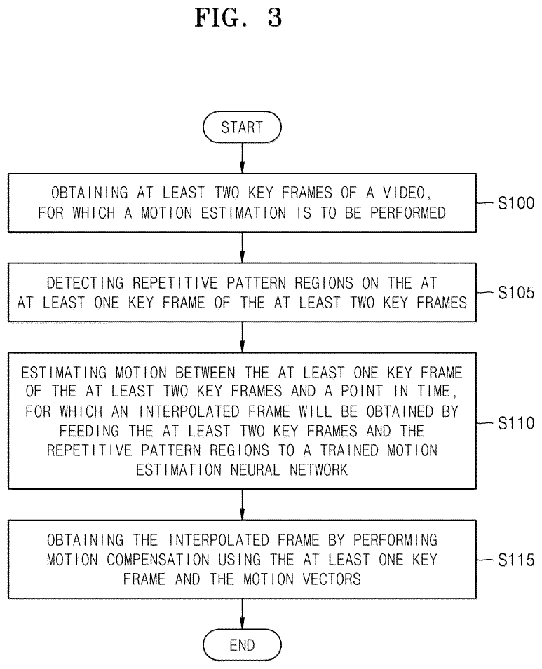

FIG. 3 illustrates the flowchart of the method for interpolating video frames according to the embodiment of the disclosure. The described sequence of operations relates to the inference stage, i.e. when the motion estimation neural network has already been trained. The term “frame interpolation” herein may correspond to a method of obtaining a video frame that includes motion estimation, motion compensation, and possibly additional algorithms such as occlusion processing, frame interpolation fallback mode not based on motion compensation, etc. The interpolation of video frames by the method proposed in this application can be performed with an increase in the frame rate of the video sequence, with a decrease in the frame rate of the video sequence, or for other purposes of processing frames of the video sequence (for example, to sharpen, or, conversely, blur certain frames of the video sequence or to perform noise reduction (Temporal Noise Reduction)).

The start of the method is initiated by receiving at operation S100 (for example, at the input of the FRC illustrated in FIG. 2) at least two video key frames for which motion estimation shall be performed, with the help of which and at least one key frame, an interpolated frame will be obtained. The received key frames can be any frames of the original video sequence subjected to frame interpolation. In some non-limiting implementations, the at least two video key frames may be input to the FRC along with a corresponding executable instruction causing the corresponding components (e.g., the processor 200.1) of the electronic device 200 to interpolate these video frames. In some implementations, fed to the input of the FRC are certain frames to be interpolated presently, or the entire video sequence to be processed at a time (as a whole) or frame by frame.

If any problems arise during frame interpolation (for example, but without limitation, related to abrupt scene change in the frame), then a special processing mode (fallback mode) or another, simpler mode for generating interpolated frame, not based on motion estimation may be used. The non-limiting example of the implementation of the fallback mode is described in the patent RU 2786784 C1 entitled as “VIDEO FRAME RATE CONVERSION METHOD SUPPORTING REPLACEMENT OF MOTION-COMPENSATED FRAME INTERPOLATION WITH LINEAR COMBINATION OF FRAMES AND DEVICE IMPLEMENTING THE SAME”.

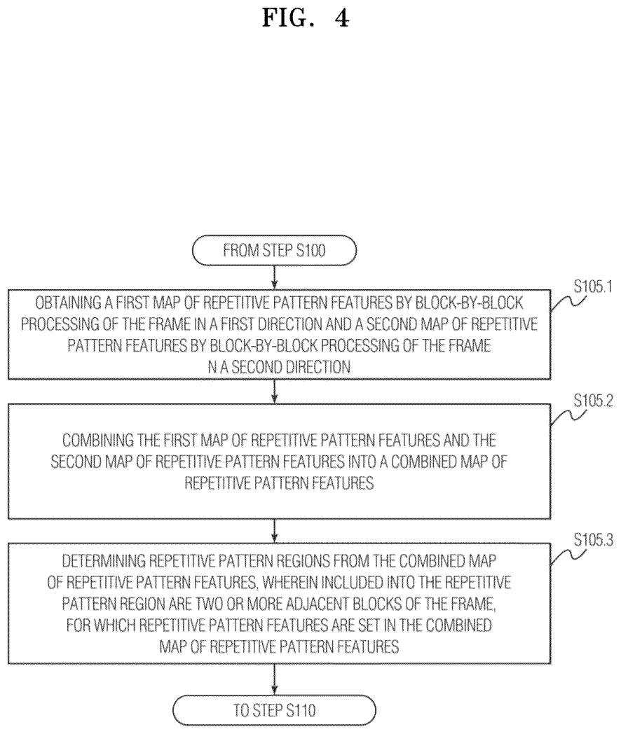

Then the method proceeds to the operation S105 of detecting repetitive pattern regions on the at least one key frame of the at least two key frames. Repetitive pattern regions are detected in a relatively fast and resource-efficient manner, which will be described in detail below with reference to FIGS. 4 to 10.

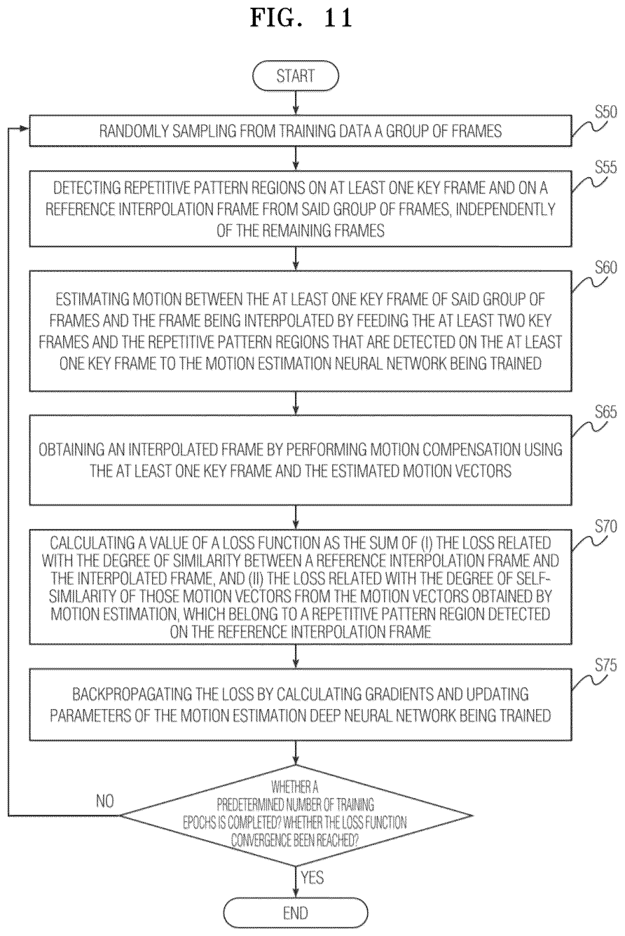

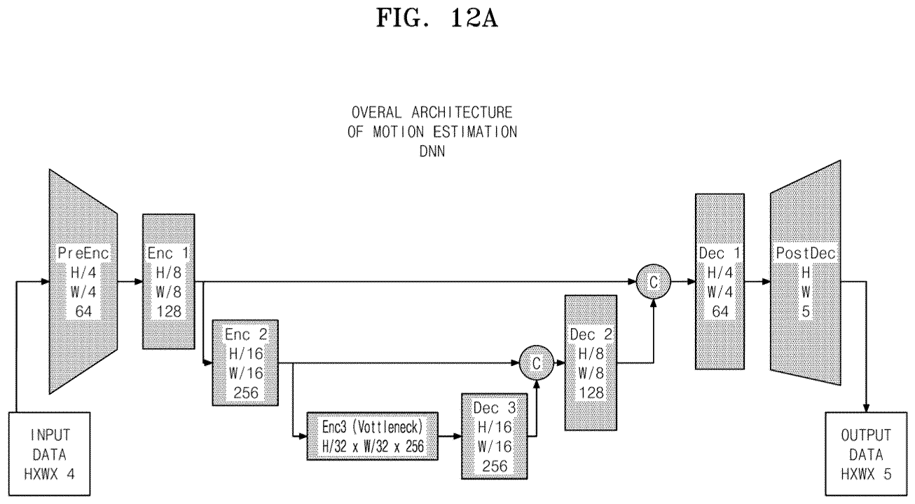

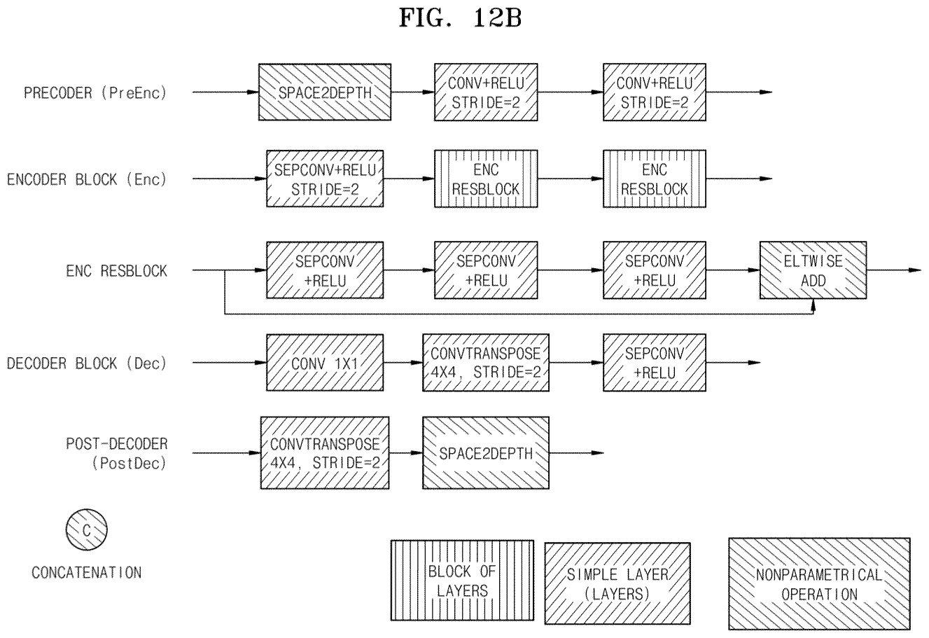

The method then proceeds to operation S110 of estimating motion between the at least one key frame of the at least two key frames and a point in time, for which the interpolated frame will be obtained, by feeding the at least two key frames and the repetitive pattern regions that are detected on the at least one key frame to the trained motion estimation neural network that is relatively lightweight, because it only implements motion estimation that takes into account the already detected repetitive patterns. How the motion estimation neural network is proposed to be trained, how the training data for training are obtained, and what the loss (error) function is proposed to be used will be described in detail below with reference to FIG. 11. The architecture of the proposed neural network will be described in detail below with reference to FIG. 12A, and the structure of the individual neural network blocks/layers will be explained in detail below with reference to FIG. 12B.

The above mentioned “point in time” may be any arbitrary point in time in between the at least two video key frames, a point in time exactly corresponding to a point in time of any of the at least two video key frames, an arbitrary point in time after a temporally later frame of the at least two video key frames or an arbitrary point in time before a temporally earlier frame of the at least two video key frames. It should be clear that in order to estimate motion between the key frame and the interpolated frame hypothesis for a particular point in time, corresponding motion estimation neural network shall be trained (or the neural network shall be trained to produce all the necessary motion estimates at once). In the non-limiting example, if motion estimation by the motion estimation neural network is desired to be performed for the point in time exactly centered on the time axis between the at least two key frames, the value of the loss function used to train the corresponding variant of the motion estimation neural network will be calculated relative to the reference interpolation frame (reference frame), which is located on the time axis exactly centered between the at least two key frames (i.e., at exactly that point in time). For example, if there is the training sequence of frames 1, 2, 3, frames 1 and 3 can be used as the key frames, and frame 2 can be used as the reference interpolation frame when training the variant of the motion estimation neural network. Other variations of the motion estimation neural network can be trained in a similar manner to produce motion estimates between key frames and other arbitrary points in time.

In some implementations of the disclosure, it is possible to provide access on the electronic device 200 to several different variants of the motion estimation neural network for estimating motion between key frames and other arbitrary points in time other than the central point in time between the frames, to subsequently obtain interpolated frames for these other arbitrary points in time. In this case, in the non-limiting example, the above-mentioned executable instruction, which may be received in operation S100, may further indicate a particular variant of the motion estimation neural network with which to perform motion estimation in operation S110 for the at least two video key frames currently received in operation S100.

Returning to the description of FIG. 3, once the operation S110 is performed, the method proceeds to executing the operation S115 of actually obtaining the interpolated frame by performing motion compensation using the at least one key frame and the motion vectors obtained by the estimation in operation S110. As mentioned above, the motion compensation can be implemented by any classical algorithm known in the art (for example, but without limitation, see the article “Displacement Measurement and Its Application in Interframe Image Coding” by Jaswant R. Jain, and Anil K. Jain, publication date: December 1981), or any motion compensation neural network known in the related art (for example, but without limitation, see the article “Real-Time Intermediate Flow Estimation for Video Frame Interpolation” by Zhewei Huang et al., date of original publication: November 2020, or the other article “View Synthesis by Appearance Flow” by Tinghui Zhou et al., date of original publication: May 2016).

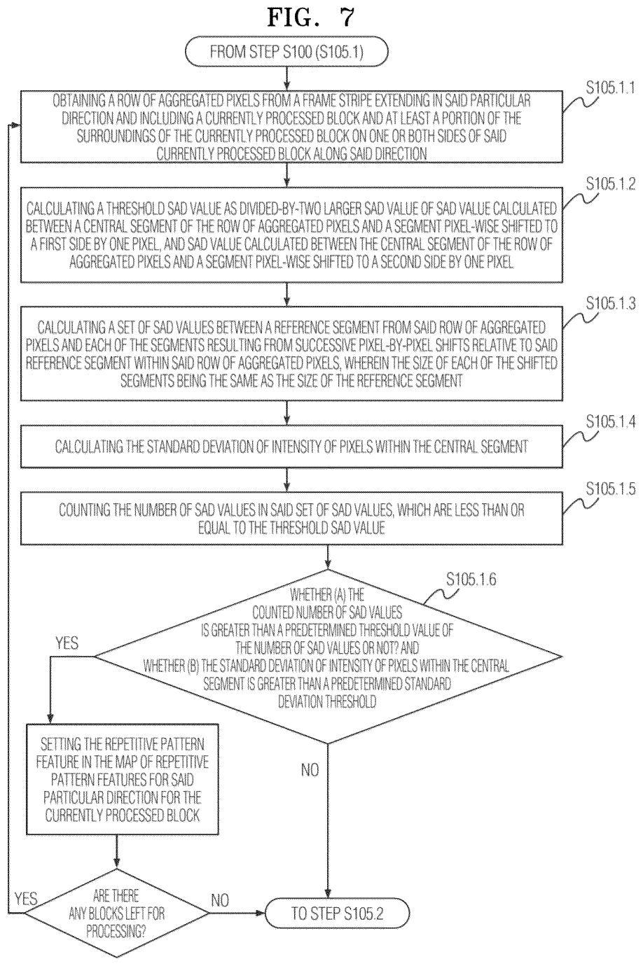

Non-limiting embodiments of detecting S105 repetitive pattern regions on key frame are described with reference to FIGS. 4 to 10. As shown in the flowchart of FIG. 4, detecting S105 repetitive pattern regions is initiated by executing the above-described operation S100 and starts from operation S105.1 of obtaining a first map of repetitive pattern features by block-by-block processing of the frame in a first direction and a second map of repetitive pattern features by block-by-block processing of the frame in a second direction. The non-limiting implementation of operation S105.1 will be described in detail below with reference to FIG. 7. In the preferred embodiment, the first direction is orthogonal to the second direction. In one example, the first and second directions are, respectively, horizontal and vertical directions, or vice versa. In the other example, the first and second directions are, respectively, a direction at an angle to a horizontal or vertical direction and a direction that is orthogonal to the angled direction. In some embodiments, additional map(s) of repetitive pattern features is (are) obtained by processing the frame in one or both diagonal directions.

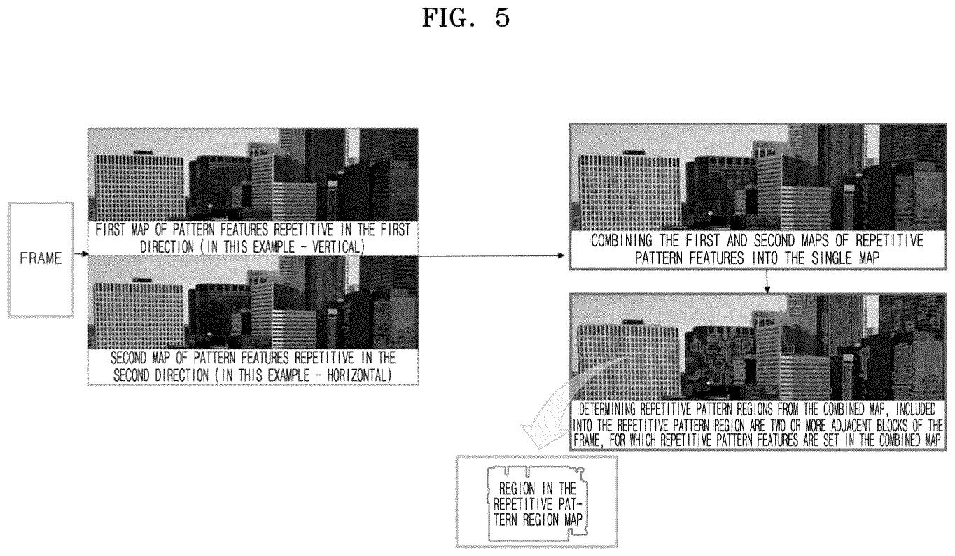

The top left of FIG. 5 illustrates the map of repetitive pattern features generated in operation S105.1 by block-by-block processing of the frame in the vertical direction, and this map of repetitive pattern features is shown superimposed on the corresponding frame. The bottom left of FIG. 5 illustrates the other map of repetitive pattern features generated for the same frame but by block-by-block processing of the frame in the different, orthogonal direction, in this case, in the horizontal direction; this map of repetitive pattern features is also shown superimposed on the corresponding frame.

In the non-limiting implementation, the frame for which maps of repetitive pattern features are obtained in operation S105.1 may, during operation S105.1 or in advance, be divided into an array of blocks of the same shape and size according to a regular grid of blocks. In the alternative implementation, the frame for which maps of repetitive pattern features are obtained in operation S105.1 may be straightaway processed in operation S105.1 (i.e., without actually dividing the frame into blocks) as the array of blocks of a predetermined uniform shape and a predetermined size. In the preferred embodiment, the blocks are square blocks, although this should not be interpreted as a limitation. In alternative embodiments, the shape of the blocks may be rectangular or even triangular. The size of the blocks should also not be limited to any specific size: as an example, blocks could be 8×8 pixels, 16×16 pixels, 32×32 pixels, 8×16 pixels, 8×32 pixels, 16×8 pixels, 32×8 pixels, 8×8×8 pixels, 8×8×16 pixels, etc. In the non-limiting implementation, in the map of repetitive pattern features, one ‘1’ may indicate a block for which the repetitive pattern feature is detected, and zero ‘0’ may indicate a block for which the repetitive pattern feature is not detected, or vice versa.

Then, the process of detecting S105 repetitive pattern regions proceeds to operation S105.2 of combining the first map of repetitive pattern features and the second map of repetitive pattern features into the combined map of repetitive pattern features. In the non-limiting example, this operation S105.2 can be implemented by the logical OR operation-if for a particular block in any of the to-be-combined maps of repetitive pattern features presence of the repetitive pattern in this block is indicated, then in the combined map of repetitive pattern features the presence of the repetitive pattern in this block is indicated (for example, by the one ‘1’); if none of the maps of repetitive pattern features indicates for a particular block the presence of the repetitive pattern in this block, then the presence of the repetitive pattern in this block is not indicated in the combined map of repetitive pattern features (for example, the value for this block in the combined map of repetitive pattern features are left equal to the initially initialized value, for example, equal to zero ‘0’). The top right of FIG. 5 illustrates the combined map of repetitive pattern features generated in operation S105.2, this combined map of repetitive pattern features is shown superimposed on the corresponding frame.

Once the operation S105.2 is performed, the process of detecting S105 repetitive pattern regions proceeds to operation S105.3 of determining the repetitive pattern regions based on the combined map of repetitive pattern features. At this operation S105.3, included into the repetitive pattern region are two or more adjacent blocks of the frame, for which repetitive pattern features are set in the combined map of repetitive pattern features. The repetitive pattern region (cluster) can be defined in different ways. Repetitive pattern regions for the entire frame can be defined by a number map in which all blocks belonging to the same region are labeled with a unique number. Repetitive pattern regions for the entire frame can be defined by the number map in which all blocks belonging to the detected regions are labeled with one number (e.g., 1) and all other blocks are labeled with a different number (e.g., 0). The repetitive pattern region can be specified by a list of blocks (for example, a block at coordinates x1, y1, a block at coordinates x2, y2, up to a block at coordinates xn, ym according to a regular grid of blocks) or in any other way.

In the non-limiting example, operation S105.3 may be implemented iteratively by the following procedure: take any block, check whether that block has the repetitive pattern feature indicated on the combined map of repetitive pattern features; if NO, take another block; if YES, proceed in all directions from this block up, down, right, left, and similarly check each block to which the transition is made; if for the blocks to which the transitions are made, the combined map of repetitive pattern features also indicates the corresponding repetitive pattern features, these blocks are added to original block in the repetitive pattern region, and similar procedure is carried out for each block newly added to this repetitive pattern region. This procedure is carried out until there are no blocks that could be added to the repetitive pattern region being generated. Thus, operation S105.3 can be implemented according to known graph search algorithms: Breadth-First Search (BFS) and Depth-First Search (DFS), or according to any equivalent algorithms and modifications thereof. In some implementations, blocks without repetitive pattern features surrounded on all sides by blocks having the repeating pattern features and belonging to the same region can be added to that region.

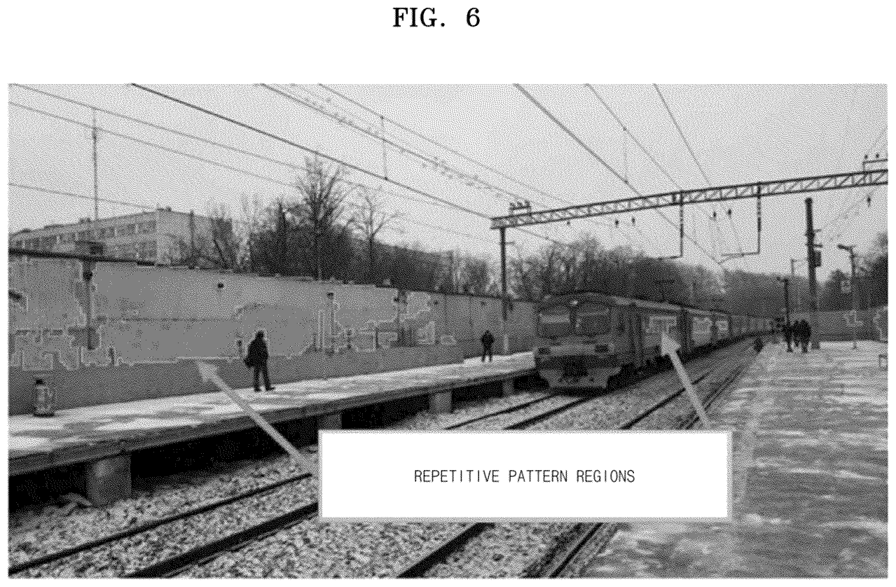

FIG. 6 illustrates one example of repetitive pattern regions detected for the frame. The detected repetitive pattern regions are shown in FIG. 6 as being superimposed on the corresponding frame on which they are detected. The minimum size of the repetitive pattern regions is equal to two adjacent blocks, for each of which the repetitive pattern feature is set in the combined map of repetitive pattern features.

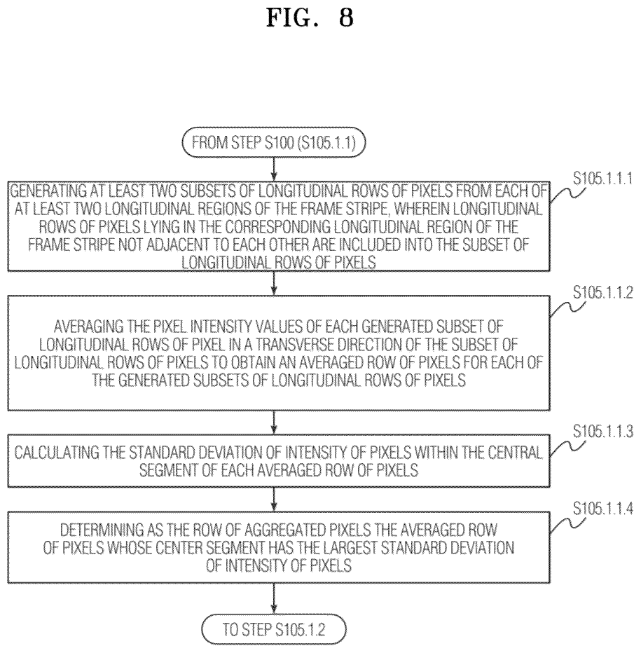

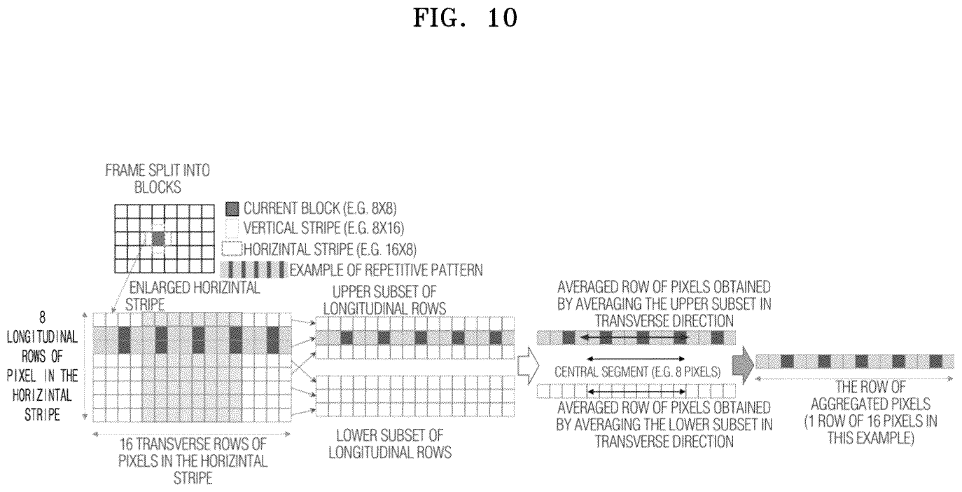

Next, FIGS. 7 to 10 of the non-limiting embodiment of operation S105.1 of obtaining the map of repetitive pattern features by block-by-block processing of the frame in the particular direction are described. As shown in the flowchart of FIG. 7, obtaining S105.1 the map of repetitive pattern features is initiated by completion of the above-described operation S100 and starts from operation S105.1.1 of obtaining the row of aggregated pixels from a frame stripe extending in the particular direction and including the currently processed block and at least the portion of the surroundings of the currently processed block on one or both sides of the currently processed block along the direction. Before describing the subsequent operations according to the flowchart of FIG. 7, it makes sense to temporarily switch to the flowchart of FIG. 8 and the additional illustration in FIG. 10, with reference to which the non-limiting implementation of operation S105.1.1 of obtaining the row of aggregated pixels from the frame stripe will now be described in detail.

As shown in FIG. 8, the non-limiting implementation of operation S105.1.1 of obtaining the row of aggregated pixels from the frame stripe is initiated by completion of operation S100 described above and starts with operation S105.1.1.1 of generating at least two subsets of longitudinal rows of pixels from each of at least two longitudinal regions of the frame stripe, wherein incorporated in the subset of longitudinal rows of pixels are longitudinal rows of pixels lying in the corresponding longitudinal region of the frame stripe not adjacent to each other. The left side of FIG. 10 shows the non-limiting illustration of how two subsets of longitudinal rows of pixels, namely the upper subset of longitudinal rows of pixels and the lower subset of longitudinal rows of pixels, can be generated.

After operation S105.1.1.1, the method proceeds to operation S105.1.1.2 of averaging pixel values (e.g. pixel intensity values) of each generated subset of longitudinal rows of pixels in a transverse direction of the subset of longitudinal rows of pixels to obtain an averaged row of pixels for each of the generated subsets of longitudinal pixel rows. In the non-limiting implementation the arithmetic mean is used at this operation S105.1.1.2 for averaging pixel values. On the right side of FIG. 10 indicated is the non-limiting illustration of two averaged rows of pixels, namely (a) the averaged row of pixels obtained by averaging in the transverse direction the upper subset of longitudinal rows of pixels, and (b) the averaged row of pixels obtained by averaging in the transverse direction the lower subset of longitudinal rows of pixels. In other words, in the non-limiting example illustrated in FIG. 10, each i^{th} pixel of the averaged row of pixels has a value obtained by averaging (in this example) three pixels located in the corresponding i^{th} column of the corresponding subset of longitudinal rows of pixels.

After operation S105.1.1.2, the method proceeds to operation S105.1.1.3 of calculating the Standard Deviation (‘STD’) of pixel values (e.g. pixel intensity values) in the central segment of each averaged row of pixels. In the non-limiting example illustrated in FIG. 10, the averaged row of pixels comprises 16 pixels, of which (in this example) the eight central pixels 5 to 12 define the central segment of the row. However, what is shown in the FIG. 10 should not be interpreted as the limitation of the disclosure, since the number of pixels included in the central segment may be more than eight, or less than eight (but not less than two pixels). In addition, in some embodiments, the segment whose pixel values are calculated at this operation S105.1.1.3 may not be located in the center of the averaged row of pixels, but may be shifted from the center in one direction or the other, provided that the shifted segment is still completely within the averaged row of pixels.

After operation S105.1.1.3, the method proceeds to operation S105.1.1.4 of determining, as the row of aggregated pixels, the longitudinal row of pixels whose central segment has the largest standard deviation of pixel values (e.g., pixel intensity values). In the non-limiting example shown in FIG. 10, determined as the row of aggregated pixels was the averaged row of pixels obtained by averaging the upper subset, since as the result of comparing the ‘STD’ values of pixels in the central segments of the averaged rows of pixels, it turned out that the ‘STD’ value of pixels in the central segment of the averaged row of pixels obtained by averaging the upper subset is greater than the ‘STD’ value of pixels in the central segment of the averaged row of pixels obtained by averaging the lower subset.

In some embodiments of operation S105.1.1.1, each two neighboring longitudinal regions of the frame stripe of the at least two longitudinal regions of the frame stripe have at least one common longitudinal row of pixels. On the left in FIG. 10 shown are 8 longitudinal rows of pixels for the horizontally directed frame stripe. In the non-limiting example illustrated in FIG. 10 of the eight rows 1 to 8 of pixels (with the rows numbering from top to bottom): rows 1 to 5 of pixels define the first longitudinal region of pixels, from which the upper subset of longitudinal rows of pixels is generated (from 1^{st}, 3^{rd}, 5^{th} rows of pixels of the first region), and rows 4 to 8 of pixels define the second longitudinal region of pixels, from which the lower subset of longitudinal rows of pixels is generated (from 4^{th}, 6^{th}, 8^{th} rows of pixels of the second region).

In the example illustrated in FIG. 10, rows 4 to 5 of pixels are two common longitudinal rows of pixels for the two adjacent regions. However, the disclosure should not be limited to the diagram illustrated in FIG. 10, since those of ordinary skill in the art will understand that the block size may differ from the illustrated pixel block size of 8×8, the frame stripe may not only be horizontal (as shown), but also vertical and diagonal (the essence of the processing described above with reference to FIG. 8 will remain the same for frame stripes other than horizontally directed ones; only modifications obvious to a skilled person will be required: for example, for a vertical frame stripe, averaging of pixel values will be performed at operation S105.1.1.2 not over the columns of the corresponding subset of rows, but over lines etc.), respectively, numbers of longitudinal and transverse rows of pixels in the frame stripe can differ from, respectively, 8 and 16, number of adjacent regions of longitudinal rows and, accordingly, number of subsets of longitudinal rows of pixels can be more than two, number of longitudinal rows included into the subset may be more than three or less than three (but at least two), the regions of longitudinal rows may have no common longitudinal row of pixels, or have only one common longitudinal row of pixels, or have more than 2 common longitudinal rows of pixels.

In addition, if the current block is the outermost block in the frame, the placement of the current block within the frame stripe may differ from that shown in FIG. 10 (i.e. not be in the center of the frame stripe). In one example, if the processing direction is the horizontal direction and the current block is the leftmost block, that block may not be in the center of the horizontal frame stripe, but instead may be at the leftmost possible position within the frame stripe. In this example, the frame stripe will not include any pixels to the left of the current block, since there are no such pixels because this block is located on the left border of the frame, but will include a larger number of pixels to the right of this block (since the size of the stripe itself is not changed in this case). In the other example, if the processing direction is the vertical direction and the current block is the topmost block, that block may not be in the center of the vertical frame stripe, but instead may be at the topmost possible position within the frame stripe. In this example, the frame stripe will not include any pixels to the above of the current block, since there are no such pixels because this block is located on the upper border of the frame, but will include a larger number of pixels to the below of this block (since the size of the stripe itself is not changed in this case). The processing described in detail above with reference to FIG. 8 and FIG. 10 will be performed for every block of frame.

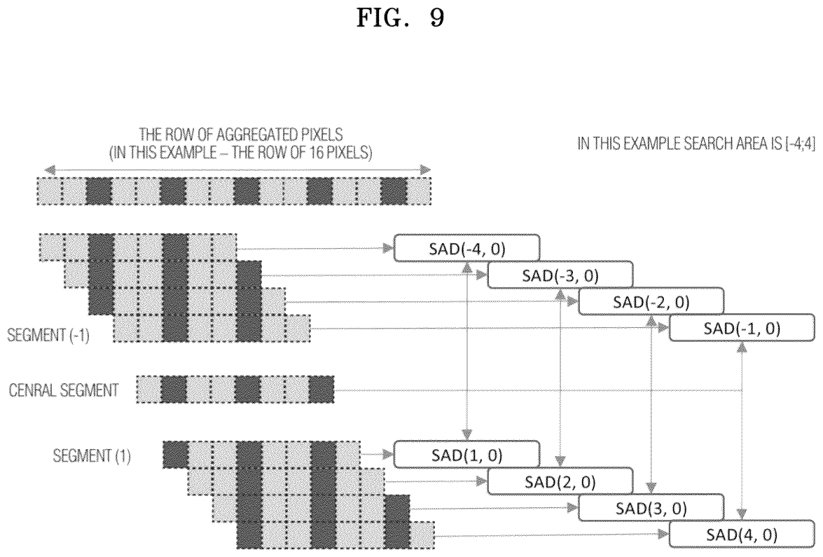

As the result of executing the last operation S105.1.1.4, the row of aggregated pixels is obtained in operation S105.1.1 from the frame stripe, and then the method proceeds to operation S105.1.2, which will be described below with reference again to FIG. 7. In operation S105.1.2 the threshold SAD (Sum of Absolute Differences) value is calculated as divided-by-two larger SAD value of a SAD value calculated between the central segment (0) of the row of aggregated pixels and the segment (−1) pixel-wise shifted to the first side by one pixel, and a SAD value calculated between the central segment (0) of the row of aggregated pixels and the segment (1) pixel-wise shifted to the second side by one pixel. The calculation of the SAD threshold is illustrated by the central part of FIG. 9. Therefore, the threshold SAD value is calculated in operation S105.1.2 according to the following mathematical expression:

$$S A D Threshold = \frac{Maximum ( S A D ( - 1 , 0 ) , S A D ( 1 , 0 ) )}{2} . \qquad ( math . expression 1 )$$

After calculating the threshold SAD value in operation S105.1.2, the method proceeds to operation S105.1.3 of calculating a set of SAD values between the reference segment from the row of aggregated pixels and each of the segments resulting from successive pixel-by-pixel shifts relative to the reference segment within the row of aggregated pixels, wherein the size of each of the shifted segments being the same as the size of the reference segment.

The selection of the reference segment may be made according to the following non-limiting implementation. The central segment of the row of aggregated pixels or the segment shifted relative to the central segment by one pixel within the row of aggregated pixels in the first or second direction is selected as the reference segment. If the SAD value calculated between the central segment and the segment shifted to the first side within the row of aggregated pixels is greater than the SAD value calculated between the central segment and the segment shifted to the second side within the row of aggregated pixels, the segment shifted to the first side is selected as the reference segment. If the SAD value calculated between the central segment and the segment shifted to the first side within the row of aggregated pixels is less than the SAD value calculated between the central segment and the segment shifted to the second side within the row of aggregated pixels, the segment shifted to the second side is selected as the reference segment. Otherwise, the central segment is selected as the reference segment, and the longitudinal size of the central and reference segment is equal to the width (when the frame is processed in the horizontal direction) or the height (when the frame is processed in the vertical direction) of the block being processed. If the segment shifted by one pixel to any side is not available (due to frame border), assigned as the reference segment is the existing segment shifted to the opposite side, and the threshold SAD value is calculated as the half of the SAD between the central and existing shifted segment.

FIG. 9 also illustrates the scheme of calculating in operation S105.1.3 the set of SAD values in the case where the reference segment is the central segment (and not the segment shifted by one pixel to either side). In the non-limiting example shown in FIG. 9, the area of search for repetitive pattern features in the block for which the row of aggregated pixels being currently processed in operation S105.1.3 is obtained can be defined as the [−4:4] area.

The size of the search area may depend on the block size and the frame stripe size, so the size of the search area may be larger or smaller than the [−4:4] size of search zones illustrated in FIG. 9. In addition, the size of the search area on one side of the reference segment may be smaller by one pixel than the size of the search area on the other side of the reference segment, when the control segment is the segment shifted to one side or another by one pixel. In addition, multiple reference segments and multiple search areas can be used in a single row of aggregated pixels.

Next, the ‘StD’ of pixels values (e.g. of pixel intensity values) in the central segment is calculated in operation S105.1.4. It should be noted here that in the actual implementation, this operation may only comprise accessing (without actual recalculation) the ‘StD’ of pixel values in the central segment, previously calculated for that row of pixels, which is determined in operation S105.1.1.4 as the row of aggregated pixels and which is currently being processed as such in operation S105.1.4.

Next, in operation S105.1.5, counting the number of SAD values in the set of SAD values, which are less than or equal to the threshold SAD value (SAD Threshold) and in operation S105.1.6 determining (a) whether the counted number (NumDetected) of SAD values is greater than a predetermined threshold value (Number Threshold) of the number of SAD values or not? and (b) whether the standard deviation of pixel values (e.g. pixel intensity values) within the central segment (Standard deviation (Central segment)) is greater than a predetermined standard deviation threshold (StD Threshold) or not?

Mathematically speaking, the number of checks and determinations can be made according to the following:

The repetitive pattern feature is detected if:

NumDetected > Number Threshold (condition (a)) and
Standard deviation (Central segment) > StD Threshold (condition (b))
where
NumDetected = Σ_{k=-4,4} Compare(SAD(k,0)) (math. expression 2)
Compare(x) = 1 if x ≤ SAD Threshold;
Compare(x) = 0 otherwise; and
SAD(0,0)=0.

SAD Threshold is determined according to the above-mentioned math. expression 1. The values of Number Threshold and StD Threshold are predetermined depending on one or more of, but not limited to, the noisiness of the source frame (the greater the high-frequency noise, the higher the values of these parameters should be), the size of the reference segment (the larger the size, the smaller the Number Threshold and higher StD Threshold should be). In the example illustrated in FIGS. 9 and 10, (StD Threshold)²=8 and Number Threshold=0 but this should not be interpreted as the limitation. Such thresholds should be set for low-noise frames. For noisier frames, threshold values can be selected empirically or, if noise parameters can be measured, taking into account ‘StD’ of the noise (StD Threshold should slightly exceed StD of the noise). In addition, k=−4,4 indicated above in math. expression 2 is only relevant for the non-limiting example of search area size illustrated in FIG. 9. In other cases, the range of the search area may differ from the range defined by the parameter k=−4,4.

If, in operation S105.1.6, both condition (a) and condition (b) are satisfied, the repetitive pattern feature (for example, one ‘1’) is set for the currently processed block in the repetitive pattern feature map generated when processing the frame in the corresponding direction. Otherwise, in the repetitive pattern feature map generated when processing the frame in the corresponding direction, the initially initialized value (for example, zero ‘0’) is left for the currently processed block. After this, it is checked whether there are still unprocessed blocks in the frame? If the unprocessed blocks remained (YES), proceeding to operation S105.1.1 and performing the entire processing, described above with reference to FIG. 7, 8, for the next block; if all blocks of the frame have already been processed (NO), proceeding to operation S105.2, which is described above in detail with reference to FIG. 4.

Next, how training data can be generated for training the motion estimation neural network (that is used in operation S110 described above) is described with reference to FIG. 3. The training data can be prepared as follows: obtaining a plurality of videos to be used as training videos. The plurality of training videos may be recorded and collected specifically for the purpose of training the neural network by manufacturer of an equipment (e.g. the manufacturer of the electronic device 200). In addition, the plurality of training videos can be obtained from sources/services that record video clips that are allowed to use for training neural networks. In addition, video clips recorded on the user devices 200 can be used, provided that the consent is obtained from the users of these devices to use such video clips for training neural networks.

Then, a plurality of groups of frames that are close to each other in time or immediately adjacent in time can be generated from each video of the plurality of videos. In some embodiments, at this operation, additional verification of the frame groups being generated can be carried out to determine whether it would be more appropriate for the frames (for example, if the complete scene change occurs in these frames) included in the individual group to obtain an interpolated frame in a simpler way (without using motion estimation), i.e., for example, according to the fallback mode. If, as the result of this verification, for a certain group of frames it is determined that it would be more appropriate for frames in this group to obtain the interpolated frame in a simpler way, such a group of frames may not be included in the training data. In other embodiments, at least some of the frames included in a particular group may be further processed (for example, but not limited to, at least one key frame in the group may be further processed to blur it, or at least one key frame in the group can be additionally processed to increase its sharpness, etc. Other additional processing of the frames, which is not described here explicitly, may be performed.

Each group of frames may be configured to contain at least three frames that are close in time or immediately adjacent in time. Of the at least three frames, at least two frames may be used as key video frames, relative to which the motion estimation neural network will estimate the motion into a hypothesis of the frame interpolated for a certain point in time, and at least one remaining frame located in time between the two key frames, or at the location of any key frame of the two key frames, or at an arbitrary point in time before the earliest frame in the corresponding group of frames, or at an arbitrary point in time after the latest in time frame in the corresponding group frames are used as the at least one reference interpolation frame (i.e., the ground truth frame), relative to which the loss of the interpolated frame obtained during training is to be calculated. From the training data obtained in this way, the following sets can be divided (retained) as separate datasets: the validation set and the test set. The purpose of the validation and test datasets is known in the art.

Next, training the motion estimation neural network (used in operation S110 described above) is described with reference to FIGS. 3 and 11. Next, one forward and backward pass in training the motion estimation neural network will be described. In actual training, a plurality of such passes shall be performed until, for example, a predetermined number of training epochs have been completed, or the loss function has converged.

The training pass begins at operation S50 of sampling a group of frames from the training data. In some cases, before performing the first training pass, the parameters (including weights) of the motion estimation neural network to be trained are initialized in a random or predetermined manner. In the next operation S55 repetitive pattern regions are detected on at least one key frame and on a reference interpolation frame from the group of frames, independently of the remaining frames. The detection of repetitive pattern regions in operation S55 may be performed similarly to the detection of repetitive pattern regions in operation S105; therefore, the detailed description of this operation S55 is not repeated here.

Then, motion is estimated in operation S60 between at least one key frame from the group of frames and the hypothesis of the frame interpolated for a certain point in time, which is similar to the point in time at which one frame of the at least one reference interpolation frame is located, which is included in the group of frames currently being processed, relative to which the loss will be calculated. This operation may be actually implemented by feeding the at least two key frames and repetitive pattern regions detected on the at least one key frame to the input of the motion estimation neural network being trained for processing and obtaining some kind of processing result at the output of the motion estimation neural network. The implementation of namely “motion estimation between at least one key frame from the group of frames and the hypothesis of the frame interpolated for a certain point in time” is subsequently achieved by, as will be described in detail below, (i) calculating the loss between the reference interpolation frame and the interpolated frame obtained by performing motion compensation using the at least one key frame and motion vectors obtained from the output of the motion estimation neural network being trained during the corresponding training pass, and (ii) back-propagating this loss during the backward phase of this pass in order to adjust the parameters of the motion estimation neural network being trained towards reducing this loss (discrepancy). Similar explanations apply to the motion estimation operation S110 described above, i.e. for the stage of inference with the trained motion estimation neural network.

Next, regularization, which can alternatively be referred to as unification, is further applied to the motion vectors of the motion vectors obtained by the motion estimation (S60), which belong to the repetitive pattern region detected in the reference interpolation frame. In this case, the calculation of the second component (ii) of the loss, i.e. loss related to the degree of self-similarity, which will be described in detail below with reference to operation S70, may be performed before the regularization is applied or after the regularization is applied. The non-limiting implementation of the regularization of motion vectors is performed by applying to the motion vectors in the repetitive pattern region (one of a local moving average, a global average, or a mode). By motion vectors “located in the repetitive pattern region” are meant herein the estimated vectors that fall within (pointing to) the repetitive pattern region of the frame, and/or vectors that originate from (starting at) the repetitive pattern region of the frame.

The interpolated frame is obtained in operation S65 by performing motion compensation using the at least one key frame and the estimated motion vectors. As stated above in this description with respect to operation S115, the motion compensation scheme that can be applied in the disclosure is not limited in any way. In other words, motion compensation can be implemented by any classical algorithm known from the related art, or by any motion compensation neural network known from the related art. However, it is desirable, but not mandatory, that the motion compensation algorithm or neural network applied at this operation S65 to obtain the interpolated frame be similar, respectively, to the motion compensation algorithm or neural network to be applied in the inference stage, i.e. in the above-described operation S115.

Once the operation S65 is performed, the training pass proceeds to execution of operation S70 of calculating a value of the loss function as the sum of (i) the loss related with the degree of similarity between the reference interpolation frame and the interpolated frame, and (ii) the loss related with the degree of self-similarity of those motion vectors of the motion vectors obtained by motion estimation, which belong to the repetitive pattern region detected on the reference interpolation frame. Due to at least the second component (ii) of the loss, the motion estimation neural network is trained to take into account repetitive pattern regions and, thereby, perform regularization of motion vectors in the repetitive pattern regions to eliminate multidirectional, sharp fluctuations of individual motion vectors in these regions.

The loss function calculated at operation S70 consists of two component terms—one taking into account and the other not taking into account the self-similarity of motion vectors, and is defined according to the following mathematical expressions:

$${Loss}_{total} = M A E ( {img}_{pred} , {img}_{gt} ) + w * {\sum }_{i ∈ \{ 0 , 1 \}} {\sum }_{j ∈ \{ x , y \}} T V ( {flow}_{i , j} )$$

where
Lossₜₒₜₐₗ—total loss function,
MAE—operation for calculating the Mean Absolute Error,
img_{pred}—interpolated frame obtained based on motion compensation performed according to the motion estimate obtained by the trained motion estimation neural network,
img_{gt}—corresponding reference (ground truth) interpolation frame,
i—key frame number (for example, 0 or 1),
j—coordinate (x or y),
flow_{i,j}—map of motion vector values along the j axis of the motion vector field, for example from key frame i to the interpolated frame,
SSmap—map of repetitive pattern regions (which can alternatively be referred to as self-similarity regions), in the non-limiting implementation when the neural network is trained, such a map is determined on the reference interpolation frame img_{gt}; frame blocks in which the repetitive pattern(s) is/are detected are specified in this map for example by ones ‘1’, frame blocks in which repetitive pattern(s) is/are not detected have a different value, e.g. zero ‘0’,
w—weighting factor for the component term of the loss function component, which is responsible for self-similarity—the network hyperparameter selected manually at the beginning of training; in the non-limiting example, the value of the weighting factor w is set to 0.001,
TV—function of Total Variation of motion vectors, which is calculated in the repetitive pattern regions specified by the map SSmap; in other possible implementations of the disclosure, variance or standard deviation may be used here instead of TV).

The total variation function used in the math. expression 3 indicated above is calculated according to the following math. expression 4:

$$T V ( SSmap , flow ) = \frac{1}{N} * {\sum }_{x , y} ( ( \vert {flow}_{x , y} - {flow}_{x - 1 , y} \vert + \vert {flow}_{x , y} - {flow}_{x + 1 , y} \vert + \vert {flow}_{x , y} - {flow}_{x , y - 1} \vert + \vert {flow}_{x , y} - {flow}_{x , y + 1} \vert ) * {SSmap}_{x , y} ) . \qquad ( math . expression 4 )$$

What has been described above for the training pass constitutes the forward pass stage. Once operation S70 is completed, this training pass ends with execution of operation S75 of performing backpropagation of the loss by computing gradients and updating parameters of the deep motion estimation neural network being trained. The backpropagation algorithm is widely known in the art and is not described in detail herein for this reason. The operations of training the deep motion estimation neural network described above with reference to FIG. 11 are performed repeatedly until a predetermined number of training epochs have been completed, or until the loss function has converged.

Any machine learning frameworks, for example, but not limited to, PyTorch, TensorFlow, Keras, can be used for implementing the training described above on a computer. Training the motion estimation neural network can be performed on the dedicated equipment (for example, a server). The parameters of the trained motion estimation neural network can be stored both on the device 200 on which it is intended to be used, and remotely on a server that the device 200 can access on demand.

Next, the non-limiting implementation of the architecture of the proposed deep motion estimation neural network will be described with reference to FIG. 12. As shown in FIG. 12A, the architecture of the proposed deep motion estimation neural network may be the UNet-based architecture with 3 layers, but it should not be limited to that number of layers. The specific number of layers and specific tensor sizes shown and described with reference to FIG. 12A are provided as the example and should not be considered as limitations of the technical solution disclosed herein. The choice of specific layer sizes (i.e., the number of channels) and the number of layers themselves is a hyper-parameter that is selected so as to provide a tradeoff between quality and performance. Typically, the minimum acceptable performance is set (dictated, for example, by the performance of the target device and/or the required number of processed frames per second) and with it the maximum possible model that satisfies the performance conditions is selected. At the same time, an infinite enlargement of the model will not lead to an infinite improvement in quality, and in the case when there are no restrictions on performance, the size of the model (and the size/number of its layers) is found beyond which the quality usually does not increase. Traditionally, these and other neural network hyper-parameters are set experimentally. The left side of the architecture shown defines the encoder, which is responsible for encoding the data to reduce its dimensionality. The right side of the architecture shown defines the decoder, which is responsible for decoding the data to increase its dimensionality.

As shown in FIG. 12A, the input data in the form of a tensor with dimensions H×W×4 (Height×Width×Number of Channels) are supplied to the input of the precoder block (PreEnc) that, as shown in FIG. 12B, consists of the sequence of blocks placed in the following order: (1) a transform block (Space2Depth), (2) a convolution block with stride of 2 and ReLU (Rectified Linear Unit) activation function, (3) a convolution block with stride 2 and ReLU activation function.

Next, data output from the precoder block are supplied as shown in FIG. 12A to the input of the first encoder block (Enc 1) that, as shown in FIG. 12B, consists of the sequence of blocks placed in the following order: (1) a separable convolution block with stride of 2 and ReLU activation function, (2) an encoder residual block (Enc Resblock), (3) an encoder residual block. Each of the encoder residual blocks, as further illustrated in FIG. 12B, consists of the sequence of blocks placed in the following order: (1) a separable convolution block (SepConv) with a stride and ReLU activation function, (2) a separable convolution block with a stride and ReLU activation function, (3) a separable convolution block with a stride and ReLU activation function, (4) pooling block (Eltwise Add) combining the results of two branches by performing an element-by-element addition of the elements of the bypass branch and the results obtained as the result of convolution.

Next, data output from the first encoder block are supplied as shown in FIG. 12A to the input of a second encoder block (Enc 2), and are also additionally conveyed via the skip connection to the input of a first decoder block (Dec 1), the structure of which will be described below. The structure of the second encoder block fully corresponds to the above-described structure of the first encoder block, which is clear from FIGS. 12A and 12b.

Next, data output from the second encoder block are supplied as shown in FIG. 12A to the input of a third encoder block (Enc 3), and are also additionally conveyed via the skip connection to the input of a second decoder block (Dec 2), the structure of which will be described below. The structure of the third encoder block fully corresponds to the above-described structure of the first and second encoder blocks, which is clear from FIGS. 12A and 12b. The third encoder block (Enc 3) is at the bottleneck layer of the UNet-based architecture shown in FIG. 12A.

Next, data output from the third encoder block are supplied as shown in FIG. 12A to the input of the third decoder block (Dec 3), which, as shown in FIG. 12B, consists of the sequence of blocks placed in the following order: (1) a convolution block with 1×1 convolution kernel (Conv 1×1), (2) a transposed convolution block with 4×4 convolution kernel and stride of 2, (3) a separable convolution block (SepConv) with a stride and ReLU activation function.

Next, data output from the third decoder block as shown in FIG. 12A are combined by concatenation with data output from the second encoder block and conveyed from the second encoder block over the corresponding skip connection, and supplied to the input of the second decoder block (Dec 2). The structure of the second decoder block fully corresponds to the above-described structure of the third decoder block, which is clear from FIGS. 12A and 12b.

Next, data output from the second decoder block as shown in FIG. 12A are combined by concatenation with data output from the first encoder block and conveyed from this first encoder block over the corresponding skip connection, and supplied to the input of the first decoder block (Dec 1). The structure of the first decoder block fully corresponds to the above-described structure of the third and second decoder blocks, which is clear from FIGS. 12A and 12b.

Next, data output from the first decoder block are supplied as shown in FIG. 12A to the input of the post-decoder block (PostDec), which, as shown in FIG. 12B, consists of the sequence of blocks placed in the following order: (1) a transposed convolution block with 4×4 convolution kernel and stride of 2, (2) a transform block (Space2Depth). As the result, output data is output from the post-decoder block (PostDec), i.e. tensor of size H×W×5, including the estimated motion, for example in the form of a field of motion vectors between the frames.

The disclosure should not be limited to the above specific convolution operation of 2, since in alternative implementations of the disclosure the convolution stride may be set to a lower value or a higher value. The same applies to convolution kernels. In addition, different convolution blocks may use different convolution stride values and/or different convolution kernels. Additionally, some implementations may use other activation functions, such as, but not limited to, Leaky ReLU activation function or hyperbolic tangent activation function, etc. In addition, different convolution blocks may use different convolution stride values. The term ‘block’ here and above is used to indicate a block of multiple neural network layers, or to indicate a simple neural network layer, or to indicate a non-parametric operation, as illustrated in FIG. 12B.

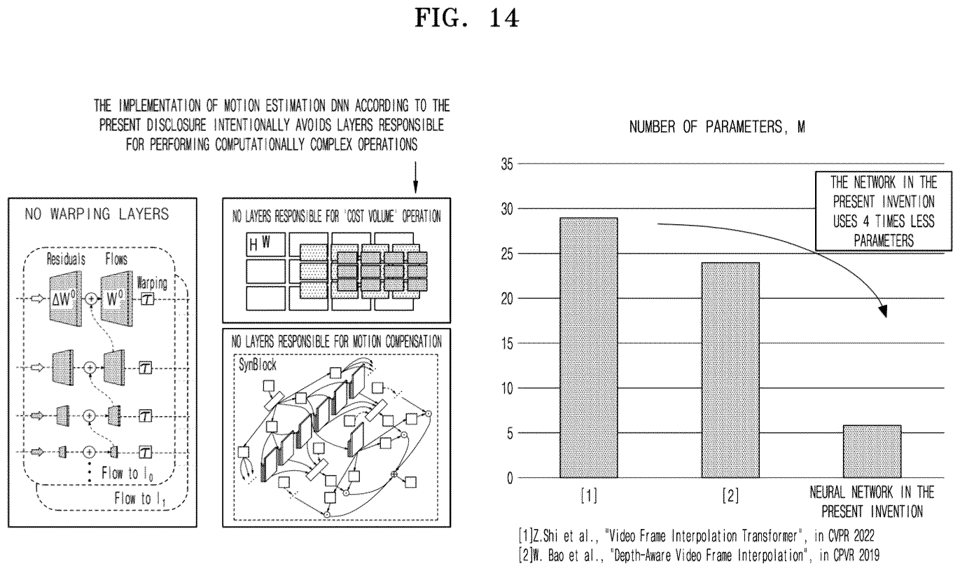

Next, with reference to FIG. 13 and FIG. 14 and the following Table 1, the beneficial technical effects achieved by the disclosure are briefly commented. Table 1 shows the PSNR metric gain that was determined on the basis of the interpolated frames obtained for particular video clips that had repetitive patterns, with the disclosure, in which the repetitive patterns were taken into account in motion estimation, and the related art solution, in which repetitive patterns were not taken into account in motion estimation.

TABLE 1
Comparison of the disclosure and the
related art in terms of PSNR metric

| | PSNR gain over the entire | PSNR gain only in repetitive |
|---|---|---|
| Video Title | interpolated frame | pattern regions |
| BirdLanding | +0.27 dB | +0.56 dB |
| Train-2 | +0.52 dB | +1.14 dB |
| Skyscrapers | +0.35 dB | +0.61 dB |
| WalkZoom4 | +0.15 dB | +0.39 dB |
| Monorail | +0.98 dB | +3.39 dB |

As can be seen from the results shown in Table 1, the disclosure improves both the overall PSNR metric calculated over the entire frame and, specifically improves this metric locally in regions of the frame in which there are repetitive patterns.

FIG. 13 illustrates the graph of PSNR-metric-based comparison of interpolated frames of the single scene obtained by the disclosure and interpolated frames obtained for the same scene according to the related art, i.e. without taking into account the patterns that are repetitive in that scene. The difference in PSNR metrics of 7.4 dB obtained for the sequence of frames of the compared videos from approximately 48th frame to approximately 75th frame, which is demonstrated in the graph, indicates that the disclosure corrected in these frames serious artifacts (for example, those described above with reference to FIG. 1) associated with the presence of repetitive patterns in these frames. In other words, the data shown in Table 1 and the graph of FIG. 13 confirm that the quality of frames in repetitive pattern regions achieved by processing with the disclosure is significantly better than that achieved by the processing, in which the disclosure is not used, and the quality of the interpolated frame achieved by the disclosure is as close as possible to the real (reference) repetitive pattern on the ground truth frame (see FIG. 1).

FIG. 14 illustrates the other technical advantage of the disclosure achieved when it is practiced. In particular, FIG. 14 shows the diagram comparing the number of parameters of the motion estimation neural network proposed in the disclosure with that of the neural networks used in the related art solutions [1] and [2]. As can be seen, the architecture of the deep motion estimation neural network disclosed herein is relatively lightweight compared to the neural networks used in the related art solutions [1] and [2]. In other words, an approximately 4-fold reduction in the number of parameters of the motion estimation neural network is achieved in comparison with the neural networks described in the related art solutions [1] and [2].

Therefore, the use of the disclosure improves the experience of the end user using the electronic device in which it is implemented, since the amount of commonly encountered artifacts generated due to incorrect motion estimation in repetitive pattern regions is significantly reduced. In addition, performance is ensured even on electronic devices with limited resources, since the architecture of the motion estimation neural network, which takes into account repeating structures, is relatively lightweight, i.e. it does not have layers responsible for such computationally complex operations as, for example, warping, cost volume, motion compensation.

One skilled in the art will appreciate that the various illustrative logical blocks (functional blocks or modules) and steps (operations) used in embodiments of the disclosed technical solution may be implemented by electronic hardware, computer software, or a combination thereof. Whether the functions are implemented with the use of hardware or software depends on particular applications and requirements to a design of an entire system. A person skilled in the art may use different methods for implementing the described functions for each particular application, but it should not be considered that such an implementation will go beyond the scope of the embodiments disclosed in the disclosure.

The order of steps of any disclosed method is not strict, because some one or more steps may be rearranged in the actual order of execution and/or combined with another one or more steps, and/or subdivided into a larger number of sub-steps.

Throughout the disclosure, a reference to an element in the singular form does not preclude the presence of a plurality of such elements in the actual implementation of the disclosure, and, conversely, a reference to an element in the plural form does not exclude the presence of only one such element in the actual implementation of the disclosure. Any specific value or range of values stated above should not be interpreted in a limiting sense, but rather such specific value or range of values should be considered to represent the midpoint of a specified larger range, up to approximately 50% or more % on either side of the specifically stated value or from the boundaries of the specifically specified smaller range.

While this disclosure has been shown and described with reference to specific embodiments and non-limiting examples thereof, those skilled in the art will appreciate that various changes in form and content may be made without departing from the spirit and scope of this disclosure as defined by the appended claims and its equivalents. In other words, the foregoing detailed description is based on specific non-limiting examples and possible implementations of the disclosure, but it should not be interpreted to mean that only the explicitly disclosed implementations are feasible. It is intended that any modification or substitution that could be made to this disclosure by one of ordinary skill in the art without creative and/or technical contribution shall be within the scope of protection (with equivalents considered) provided by the following claims.

What is claimed is:

1. A method for interpolating video frames, the method comprising:
obtaining at least two key frames of a video, for which a motion estimation is to be performed,
detecting repetitive pattern regions on the at least one key frame of the at least two key frames,
estimating motion between the at least one key frame of the at least two key frames and a point in time, for which an interpolated frame will be obtained by feeding the at least two key frames and the repetitive pattern regions to a trained motion estimation neural network,
wherein, when a training of the motion estimation neural network is performed, a value of a loss function is calculated as the sum of:
(i) a loss related with a degree of similarity between a reference interpolation frame and the interpolated frame, and
(ii) the loss related with the degree of self-similarity of motion vectors obtained by motion estimation in the training of the motion estimation neural network, wherein the motion vectors belong to a repetitive pattern region detected on the reference interpolation frame,
obtaining the interpolated frame by performing motion compensation using the at least one key frame and the motion vectors.

2. The method of claim 1, wherein, when the training of the motion estimation neural network is performed, the method further comprising applying regularization to the motion vectors,
wherein the loss related with the degree of self-similarity is calculated before the regularization is applied to the motion vectors or after the regularization is applied to the motion vectors.

3. The method of claim 1, wherein the motion being estimated are motion vectors into or from the at least one key frame.

4. The method of claim 2, wherein:
when the motion vectors being estimated are motion vectors into the at least one key frame, the motion vectors, which belong to the repetitive pattern region, begin in the repetitive pattern region, or
when the motion vectors being estimated are motion vectors from the at least one key frame, the motion vectors, which belong to the repetitive pattern region, end in the repetitive pattern region.

5. The method of claim 4, wherein the regularization of motion vectors is performed by applying to the motion vectors in the repetitive pattern region.

6. The method of claim 1, wherein the detecting the repetitive pattern regions on the frame, comprises:
obtaining a first map of repetitive pattern features by block-by-block processing of the frame in a first direction and a second map of repetitive pattern features by block-by-block processing of the frame in a second direction,
combining the first map of repetitive pattern features and the second map of repetitive pattern features into a combined map of repetitive pattern features, and
determining repetitive pattern regions from the combined map of repetitive pattern features,
wherein the repetitive pattern region are two or more adjacent blocks of the frame, for which repetitive pattern features are set in the combined map of repetitive pattern features.

7. The method of claim 6, wherein the first direction is orthogonal to the second direction.

8. The method of claim 7, wherein the first and second directions are, respectively, horizontal and vertical directions, or
wherein the first and second directions are, respectively, vertical and horizontal directions, or
wherein the first and second directions are, respectively, a direction angled to the horizontal or vertical direction and a direction that is orthogonal to the direction angled to the horizontal or vertical direction.

9. The method of claim 1, wherein the detecting the repetitive pattern regions on the frame, comprises:
obtaining:
a map of horizontally repetitive pattern features by block-by-block processing of the frame in the horizontal direction,
a map of vertically repetitive pattern features by block-by-block processing of the frame in the vertical direction,
a map of first diagonally repetitive pattern features by block-by-block processing of the frame in the first diagonal direction, and
a map of second diagonally repetitive pattern features by block-by-block processing of the frame in the second diagonal direction,
combining the obtained maps of repetitive pattern features into a combined map of repetitive pattern features,
determining repetitive pattern regions from the combined map of repetitive pattern features to obtain repetitive pattern regions,
wherein the repetitive pattern region of the map of repetitive pattern regions are two or more adjacent blocks of the frame, for which repetitive pattern features are set in the combined map of repetitive pattern features.

10. The method of claim 9, wherein the first diagonal direction is the direction from the lower left corner of the frame to the upper right corner of the frame, and the second diagonal direction is the direction from the upper left corner of the frame to the lower right corner of the frame, or
wherein the first diagonal direction is the direction from the lower right corner of the frame to the upper left corner of the frame, and the second diagonal direction is the direction from the upper right corner of the frame to the lower left corner of the frame, or
wherein the first diagonal direction is the direction from the upper left corner of the frame to the lower right corner of the frame, and the second diagonal direction is the direction from the lower left corner of the frame to the upper right corner of the frame, or
wherein the first diagonal direction is the direction from the upper right corner of the frame to the lower left corner of the frame, and the second diagonal direction is the direction from the lower right corner of the frame to the upper left corner of the frame.

11. The method of claim 6, wherein the obtaining the map of repetitive pattern features by block-by-block processing of the frame in a particular direction of the first direction and the second direction, comprises performing the following operations for each block of the frame:
obtaining a row of aggregated pixels from a frame stripe extending in a particular direction and including a block being processed currently and at least a portion of the surroundings of the block being processed on one or both sides of the block being processed along the direction,
calculating a threshold (sum of absolute differences) SAD value as divided-by-two larger SAD value of a SAD value calculated between a central segment of the row of aggregated pixels and a segment pixel-wise shifted to a first side by one pixel, and a SAD value calculated between the central segment of the row of aggregated pixels and a segment pixel-wise shifted to a second side by one pixel,
calculating a set of SAD values between a reference segment from the row of aggregated pixels and each of the segments resulting from successive pixel-by-pixel shifts relative to the reference segment within the row of aggregated pixels, wherein the size of each of the shifted segments is the same as the size of the reference segment,
calculating the standard deviation of intensity of pixels within the central segment,
counting the number of SAD values in the set of SAD values, which are less than or equal to the threshold SAD value, and
setting the repetitive pattern feature in the map of repetitive pattern features for the particular direction for the block being processed when (a) the counted number of SAD values is greater than a predetermined threshold value of the number of SAD values and (b) the standard deviation of intensity of pixels within the central segment is greater than a predetermined standard deviation threshold.

12. The method of claim 11, wherein when, in the operation of setting, at least one of the conditions (a), (b) is not satisfied, the operation of obtaining the map of repetitive pattern features proceeds to processing the next block of the frame without setting in the corresponding map of repetitive pattern features the repetitive pattern feature for the current block.

13. The method of claim 11, wherein an operation of pixel shift used to obtain the shifted segments in the operation of calculating the set of SAD values is one pixel.

14. The method of claim 11, wherein selected as the reference segment is a central segment of the row of aggregated pixels or a segment shifted relative to the central segment by one pixel within the row of aggregated pixels in the first or second direction,
wherein, if the SAD value calculated between the central segment and the segment shifted to the first side within the row of aggregated pixels is greater than the SAD value calculated between the central segment and the segment shifted to the second side within the row of aggregated pixels, the segment shifted to the first side is selected as the reference segment,
wherein, if the SAD value calculated between the central segment and the segment shifted to the first side within the row of aggregated pixels is less than the SAD value calculated between the central segment and the segment shifted to the second side within the row of aggregated pixels, the segment shifted to the second side is selected as the reference segment,
otherwise, the central segment is selected as the reference segment,
wherein the longitudinal size of the central and reference segment is equal to the width or height of the block being processed.

15. The method of claim 11, wherein the obtaining the row of aggregated pixels from the frame stripe extending in the particular direction and including the block being processed currently and at least the portion of the surroundings of the block being processed currently, which is located within the frame stripe, comprises:
generating at least two subsets of longitudinal rows of pixels from each of at least two longitudinal regions of the frame stripe, wherein the subset of longitudinal rows of pixels includes longitudinal rows of pixels lying in the corresponding longitudinal region of the frame stripe not adjacent to each other,
averaging the pixel intensity values of each generated subset of longitudinal pixel rows in a transverse direction of the subset of longitudinal pixel rows to obtain an averaged row of pixels for each of the generated subsets of longitudinal pixel rows, and
calculating the standard deviation of intensity of pixels within the central segment of each averaged row of pixels, and
determining as the row of aggregated pixels the averaged row of pixels whose center segment has the largest standard deviation of intensity of pixels.

16. The method of claim 15, wherein the generating subsets of longitudinal rows of pixels each two neighboring longitudinal regions of the frame stripe of the at least two longitudinal regions of the frame stripe comprise at least one common longitudinal row of pixels.

17. The method of claim 15, wherein the number of generated subsets of longitudinal rows of pixels and longitudinal regions of the frame stripe is selected depending on the resolution of the frame being processed or on the size of the frame block being processed.

18. The method of claim 15, wherein the operation of calculating further comprises calculating the standard deviation of intensity of pixels within the central segment of one or more longitudinal rows of pixels of the frame stripe, which are not included, in generating into a subset of longitudinal rows of pixels, and
in the operation of determining, determined as the row of aggregated pixels is the longitudinal row of pixels whose central segment has the largest normalized standard deviation of intensity of pixels among the averaged rows of pixels and, the one or more longitudinal rows of pixels of the frame stripe, which are not included, in generating into a subset of longitudinal rows of pixels.

19. A video frame interpolation device comprising:
memory storing one or more instructions; and
at least one a processor configured to execute the one or more instructions stored in the memory,
wherein the one or more instructions, when executed by the at least one processor, cause the video frame interpolation device to perform the method of any one of claim 1.

20. A non-transitory computer-readable medium storing computer-executable instructions that, when executed, cause the computer to perform a method according to any one of claim 1.
